(19) United States
(12) Patent Application Publication
(10) Pub. No.: US 2018/0324717 A1
(43) Pub. Date: Nov. 8, 2018

(54) MULTIPLE SERVICE SET WAKEUP FRAME

(71) Applicant: QUALCOMM Incorporated, San Diego, CA (US)

(72) Inventors: Yan ZHOU, San Diego, CA (US); George CHERIAN, San Diego, CA (US)

(21) Appl. No.: 15/970,606

(22) Filed: May 3, 2018

Related U.S. Application Data
(60) Provisional application No. 62/502,596, filed on May 5, 2017.

(51) Int. Cl. H04W 52/54; H04W 52/02

(52) U.S. Cl. CPC H04W 52/54; H04W 52/0216; H04W 84/12; H04W 52/0235; H04W 52/0219

(57) ABSTRACT

Various aspects of the disclosure relate to communication using a wakeup frame for multiple service sets. For example, a single wakeup frame may be used to wakeup different sets of STAs served by different basis service sets (BSSs). To this end, the wakeup frame may include: an indication of whether the frame is for a single service set or multiple service sets, at least one wakeup field (e.g., one for each service set), an indication of the number of wakeup fields in the frame, or any combination thereof.

### CROSS-REFERENCE TO RELATED APPLICATION(S)

This application claims priority to and the benefit of provisional patent application No. 62/502,596 filed in the U.S. Patent and Trademark Office on May 5, 2017, the entire content of which is incorporated herein by reference.

### INTRODUCTION

Various aspects described herein relate to wireless communication and, more particularly but not exclusively, to a wakeup frame for multiple service sets.

Wireless communication networks are widely deployed to provide various communication services such as telephony, video, data, messaging, broadcasts, and so on. Such networks, which are usually multiple access networks, support communications for multiple users by sharing the available network resources.

Within such wireless networks a variety of data services may be provided, including voice, video, and emails. More recently, wireless communication networks are being utilized for an even broader range of services and larger numbers of users. As the demand for mobile broadband access continues to increase, research and development continue to advance wireless communication technologies not only to meet the growing demand for mobile broadband access, but to advance and enhance the user experience.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

In some aspects, the disclosure provides an apparatus configured for communication. The apparatus includes a processing system and an interface. The processing system is configured to generate a frame including a first field having a first indication indicating that the frame includes one wakeup field or a plurality of wakeup fields, wherein each wakeup field comprises a wakeup indication for a corresponding service set. The interface is configured to output the frame for transmission.

In some aspects, the disclosure provides a method for communication. The method includes: generating a frame including a first field having a first indication indicating that the frame includes one wakeup field or a plurality of wakeup fields, wherein each wakeup field comprises a wakeup indication for a corresponding service set; and outputting the frame for transmission.

In some aspects, the disclosure provides an apparatus configured for communication. The apparatus includes: means for generating a frame including a first field having a first indication indicating that the frame includes one wakeup field or a plurality of wakeup fields, wherein each wakeup field comprises a wakeup indication for a corresponding service set; and means for outputting the frame for transmission.

In some aspects, the disclosure provides a wireless node including a processing system and a transmitter. The processing system is configured to generate a frame including a first field having a first indication indicating that the frame includes one wakeup field or a plurality of wakeup fields, wherein each wakeup field comprises a wakeup indication for a corresponding service set. The transmitter is configured to transmit the frame.

In some aspects, the disclosure provides a computer-readable medium (e.g., a non-transitory computer-readable medium) storing computer-executable code. The computer-executable code includes code to: generate a frame including a first field having a first indication indicating that the frame includes one wakeup field or a plurality of wakeup fields, wherein each wakeup field comprises a wakeup indication for a corresponding service set; and output the frame for transmission.

In some aspects, the disclosure provides an apparatus configured for communication. The apparatus includes an interface and processing system. The interface is configured to obtain a frame including a first field having a first indication indicating that the frame includes one wakeup field or a plurality of wakeup fields, wherein each wakeup field comprises a wakeup indication for a corresponding service set. The processing system is configured to determine, based on the first indication, whether the frame includes the plurality of wakeup fields, determine whether the wakeup indication of one of the plurality of wakeup fields is associated with a particular wireless node if the determination based on the first indication is that the frame includes the plurality of wakeup fields, and generate a wakeup signal for a transceiver based on the determination of whether the wakeup indication of one of the plurality of wakeup fields is associated with the particular wireless node, wherein the interface is further configured to output the wakeup signal.

In some aspects, the disclosure provides a method for communication. The method includes: obtaining a frame including a first field having a first indication indicating that the frame includes one wakeup field or a plurality of wakeup fields, wherein each wakeup field comprises a wakeup indication for a corresponding service set; determining, based on the first indication, whether the frame includes the plurality of wakeup fields; determining whether the wakeup indication of one of the plurality of wakeup fields is associated with a particular wireless node if the determination based on the first indication is that the frame includes the plurality of wakeup fields; generating a wakeup signal for a transceiver based on the determination of whether the wakeup indication of one of the plurality of wakeup fields is associated with the particular wireless node; and outputting the wakeup signal.

In some aspects, the disclosure provides an apparatus configured for communication. The apparatus includes: means for obtaining a frame including a first field having a first indication indicating that the frame includes one wakeup field or a plurality of wakeup fields, wherein each wakeup field comprises a wakeup indication for a corresponding service set; means for determining, based on the first indication, whether the frame includes the plurality of wakeup fields; means for determining whether the wakeup indication of one of the plurality of wakeup fields is associated with a particular wireless node if the determination based on the first indication is that the frame includes the plurality of wakeup fields; means for generating a wakeup signal for a transceiver based on the determination of whether the wakeup indication of one of the plurality of wakeup fields is associated with the particular wireless node; and means for outputting the wakeup signal.

In some aspects, the disclosure provides a wireless node including a receiver and a processing system. The receiver is configured to receive a frame including a first field having a first indication indicating that the frame includes one wakeup field or a plurality of wakeup fields, wherein each wakeup field comprises a wakeup indication for a corresponding service set. The processing system is configured to determine, based on the first indication, whether the frame includes the plurality of wakeup fields, determine whether the wakeup indication of one of the plurality of wakeup fields is associated with a particular wireless node if the determination based on the first indication is that the frame includes the plurality of wakeup fields, generate a wakeup signal for a transceiver based on the determination of whether the wakeup indication of one of the plurality of wakeup fields is associated with the particular wireless node, and output the wakeup signal to a transmitter.

In some aspects, the disclosure provides a computer-readable medium (e.g., a non-transitory computer-readable medium) storing computer-executable code. The computer-executable code includes code to: obtain a frame including a first field having a first indication indicating that the frame includes one wakeup field or a plurality of wakeup fields, wherein each wakeup field comprises a wakeup indication for a corresponding service set; determine, based on the first indication, whether the frame includes the plurality of wakeup fields; determine whether the wakeup indication of one of the plurality of wakeup fields is associated with a particular wireless node if the determination based on the first indication is that the frame includes the plurality of wakeup fields; generate a wakeup signal for a transceiver based on the determination of whether the wakeup indication of one of the plurality of wakeup fields is associated with the particular wireless node; and output the wakeup signal.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations it should be understood that such implementations can be implemented in various devices, systems, and methods.

### BRIEF DESCRIPTION OF THE DRAWINGS

The accompanying drawings are presented to aid in the description of aspects of the disclosure and are provided solely for illustration of the aspects and not limitations thereof.

FIG. 1 illustrates an example of a wireless communication system including basis service sets.

FIG. 2 illustrates an example of a wireless communication system in which aspects of the present disclosure may be employed.

FIG. 3 illustrates an example of a BSS wakeup frame.

FIG. 4 illustrates an example of a multiple BSSID element.

FIG. 5 illustrates an example of a multiple BSS wakeup frame in accordance with some aspects of the disclosure.

FIG. 6 illustrates another example of a wireless communication system in which aspects of the present disclosure may be employed.

FIG. 7 illustrates another example of a wireless communication system in which aspects of the present disclosure may be employed.

FIG. 8 is a functional block diagram of an example apparatus that may be employed within a wireless communication system in accordance with some aspects of the disclosure.

FIG. 9 is a functional block diagram of example components that may be utilized in the apparatus of FIG. 8 to transmit wireless communication.

FIG. 10 is a functional block diagram of example components that may be utilized in the apparatus of FIG. 8 to receive wireless communication.

FIG. 11 is a functional block diagram of an example apparatus in accordance with some aspects of the disclosure.

FIG. 12 is a flow diagram of an example process for providing a frame with at least one wakeup field in accordance with some aspects of the disclosure.

FIG. 13 is a flow diagram of an example process for processing a frame with at least one wakeup field in accordance with some aspects of the disclosure.

FIG. 14 is a simplified block diagram of several sample aspects of an apparatus configured to provide a frame with at least one wakeup field in accordance with some aspects of the disclosure.

FIG. 15 is a simplified block diagram of several sample aspects of an apparatus configured to process a frame with at least one wakeup field in accordance with some aspects of the disclosure.

FIG. 16 is a simplified block diagram of several sample aspects of a memory configured with code to provide a frame with at least one wakeup field in accordance with some aspects of the disclosure

FIG. 17 is a simplified block diagram of several sample aspects of a memory configured with code to process a frame with at least one wakeup field in accordance with some aspects of the disclosure.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may include at least one element of a claim. As an example of the above, in some aspects, a method of communication includes generating a frame including a first field for a first indication of whether the frame includes a plurality of wakeup fields, wherein each wakeup field comprises a wakeup indication for a corresponding service set; and outputting the frame for transmission.

The concepts described herein may be used in an IEEE 802.11-based network (also referred to as a Wi-Fi network), for example, future revisions of the 802.11ax standard or to be developed Wi-Fi standards, or may be used in other types of wireless communication systems. For purposes of illustration, the following may describe various aspects in the context of a Wi-Fi network. It should be appreciated, however, that the teachings herein may be used in other systems as well. Thus, references to functionality in the context of Wi-Fi network terminology should be understood to be equally applicable to other types of technology, networks, components, signaling, and so on.

### Example Wi-Fi Network

An access point (AP) in a Wi-Fi network may employ Virtual AP (VAP) capabilities whereby a single, physical AP functions like multiple APs. Thus, a single AP can provide separate WLANs to serve different sets of users.

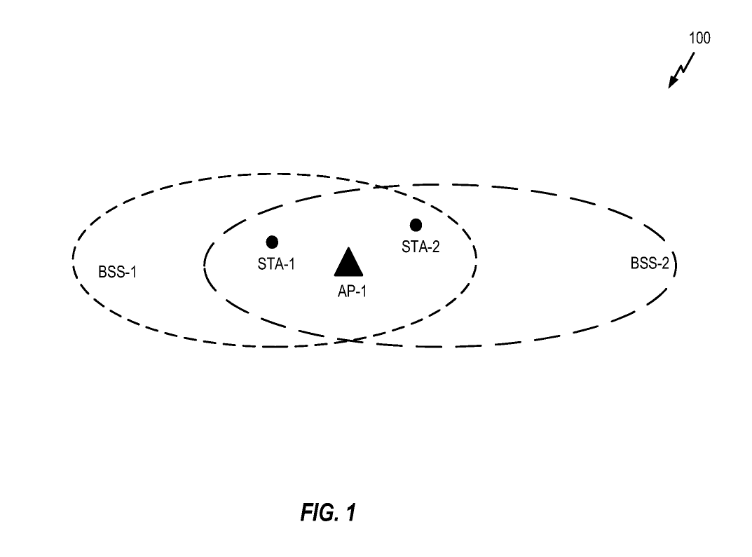

For example, FIG. 1 illustrates a wireless communication system 100 where an access point AP-1 provides two basis service sets (BSSs), a first basic service set BSS-1 and a second basic service set BSS-2. Accordingly, a first station STA-1 belonging to (e.g., currently served by) the first basic service set BSS-1 of the access point AP-1 may also receive transmissions for the second basic service set BSS-2 of the access point AP-1. Conversely, a second station STA-2 belonging to the second basic service set BSS-2 of the access point AP-1 may also receive transmissions for the first basic service set BSS-1 of the access point AP-1.

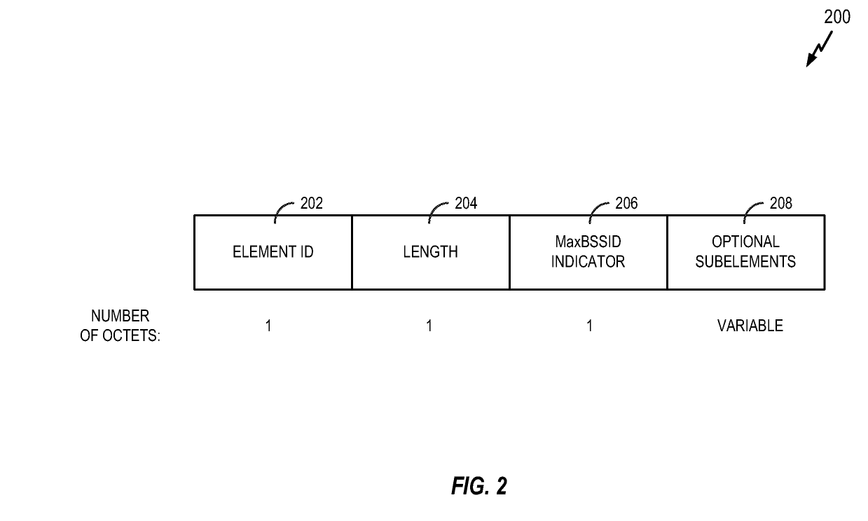

In a system with “n” VAPs, “n” beacon frames are needed, resulting in relatively high airtime consumption for beacon transmissions. Accordingly, the concept of a Multiple BSS identifier (BSSID) element 200 as shown in FIG. 2 has been proposed for collapsing information for multiple BSSIDs (or SSIDs) into one single beacon frame. The element 200 includes an Element ID field 202, a Length field 204, a maximum BSSID (MaxBSSID) Indicator field 206, and an Optional Subelements field 208. Here, the BSSID of the particular VAP that transmits the multiple BSSID element 200 is defined as the transmitted BSSID.

### Low Power Radio

Low-power IEEE 802.11 devices may be equipped with a low-power wake-up radio to achieve a better tradeoff between power efficiency and latency. In the discussions that follow, a conventional IEEE 802.11 radio may be referred to as a main radio (MR) and the companion low-power Wake-Up Radio (e.g., a dedicated wakeup radio) may be referred to as a WUR.

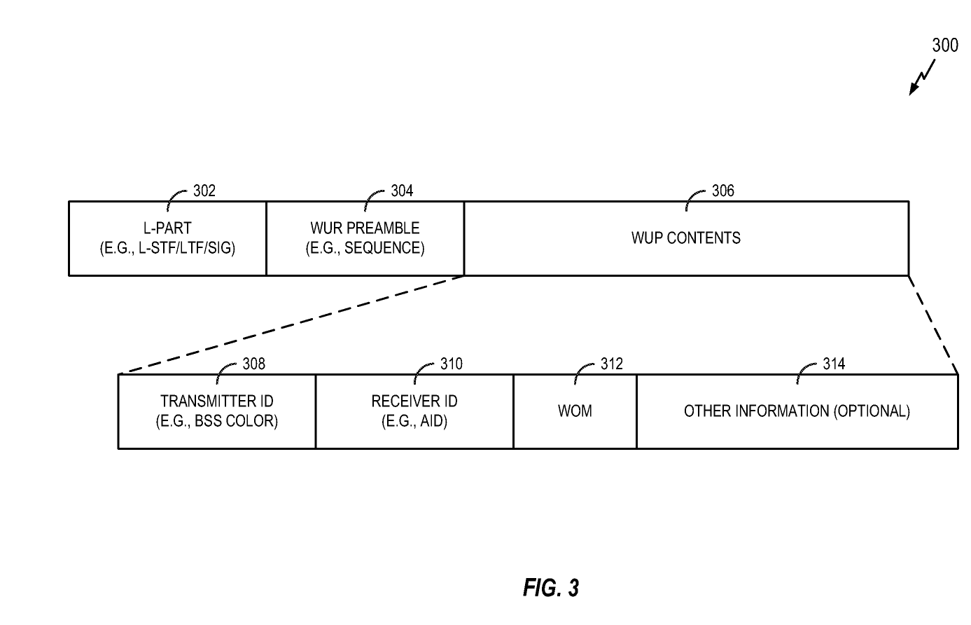

An example of a single BSS wakeup frame 300 is shown in FIG. 3. The frame 300 includes a legacy part (L-Part) field 302, a WUR Preamble field 304, and a wakeup (WUP) Contents field 306. The L-Part field 302 may include, for example, a legacy short training field (L-STF), a legacy long training field (L-LTF), and a legacy signal field (L-SIG). The WUP Contents field 306 includes a Transmitter ID (e.g., BSS Color or BSSID) 308, a Receiver ID (e.g., an association ID, AID) 310, a WUR Operation Mode (WOM) 312, and optionally other information 314. The WOM 312 may include a bit that stands for: 0—No wake-up, 1—Wake-up. The other information 314 may include, for example, a traffic indication map (TIM).

The Receiver ID may include an Individual ID, a Broadcast ID, a Group ID, a TIM indication (e.g., a special value), or other information. A WUR ID can be used to identify a WUR mode STA instead of using an AID For example, a WUR ID may be allocated when entering WUR mode.

### Multiple BSS Wakeup Frame

If a physical AP supports multiple BSSIDs, it may be more efficient for the AP to send a single wakeup frame to wake up STAs associated with different BSSIDs. In this way, the AP may avoid sending multiple wakeup frames for different BSSIDs.

The disclosure relates in some aspects to a multiple BSSID wakeup frame. Such a frame may include one or more of the following aspects: potential format, transmitter address and/or receiver address (TA/RA) setting rule, short IDs in the wakeup frame; selection rule for single and multiple BSSID wakeup frames; and options to set the RA in a response frame.

### Example Wireless Communication System

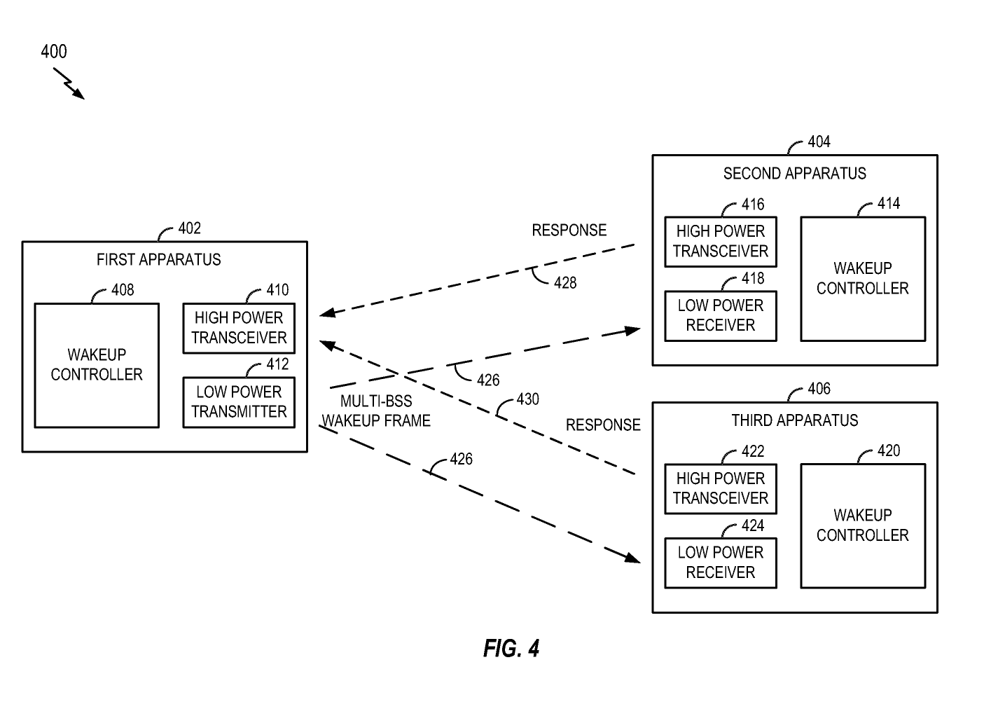

FIG. 4 illustrates a wireless communication system 400 that includes a first apparatus 402 (e.g., an AP), a second apparatus 404 (e.g., a STA), and a third apparatus 406 (e.g., a STA). In practice, a wireless communication system may include a different number of apparatuses.

The first apparatus 402 has VAP capabilities, whereby the first apparatus 402 may provide different WLANs for different sets of users. As discussed above, each of these VAPs (and, hence, each of these WLANs) is associated with a corresponding BSS (and, hence, a corresponding BSSID). One or more of the VAPs of the first apparatus 402 may broadcast a Multiple BSSID element as discussed above in conjunction with FIG. 2.

The first apparatus 402, the second apparatus 404, and the third apparatus 406 support wakeup functionality. For example, each of the second apparatus 404 and the third apparatus 406 may switch to a low power mode when that apparatus is not sending or receiving traffic. In some aspects, the low power mode may involve switching the main radios of the second apparatus 404 or the third apparatus 406 to a low power mode (e.g., disabling some or all of the functional of the main radio). The first apparatus 402, the second apparatus 404, and the third apparatus 406 may each include a respective WUR, whereby a WUR of the first apparatus 402 can send a Multiple BSSID Wakeup Frame to the respective WURs of the second apparatus 404 and the third apparatus 406 to wakeup the second apparatus 404 and the third apparatus 406. These operations will be discussed further in the context of the components shown in FIG. 4.

The first apparatus 402 includes a wakeup controller 408, a high power transceiver 410 (e.g., a main Wi-Fi radio), and a low power transmitter 412 (e.g., a WUR transmitter, also referred to as a dedicated wakeup transmitter). The second apparatus 404 includes a wakeup controller 414, a high power transceiver 416 (e.g., a main Wi-Fi radio), and a low power receiver 418 (e.g., a WUR receiver, also referred to as a dedicated wakeup receiver). The third apparatus 406 includes a wakeup controller 420, a high power transceiver 422 (e.g., a main Wi-Fi radio), and a low power receiver 424 (e.g., a WUR receiver).

The first apparatus 402 may provide VAP functionality. Thus, the second apparatus 404 may be served by a first BSS of the first apparatus 402, while the third apparatus 406 may be served by a second BSS of the first apparatus 402. At some point in time, the second apparatus 404 and the third apparatus 406 may each switch to a low power mode. In this case, the wakeup controller 414 may switch the high power transceiver 416 to a low power mode (e.g., turned off) and the wakeup controller 420 may switch the high power transceiver 422 to a low power mode (e.g., turned off). When the first apparatus 402 subsequently needs to communicate with the second apparatus 404 and/or third apparatus 406, the wakeup controller 408 causes the low power transmitter 412 to transmit a multi-BSS wakeup frame 426 (represented by dashed lines in FIG. 4). The frame 426 is received by the low power receivers 418 and 424. In response, the wakeup controller 414 switches the high power transceiver 416 back to a regular operational mode (e.g., turned back on) and the wakeup controller 420 switches the high power transceiver 422 back to a regular operational mode (e.g., turned back on). The second apparatus 404 and the third apparatus 406 may then send responses (e.g., acknowledgements) to the first apparatus 402. For example, the high power transceiver 416 may send a response 428 (represented by a dashed line in FIG. 4) to the high power transceiver 410 of the first apparatus 402. Similarly, the high power transceiver 422 may send a response 430 (represented by a dashed line in FIG. 4) to the high power transceiver 410 of the first apparatus 402.

### Example Multiple BSSID Wakeup Frame Format

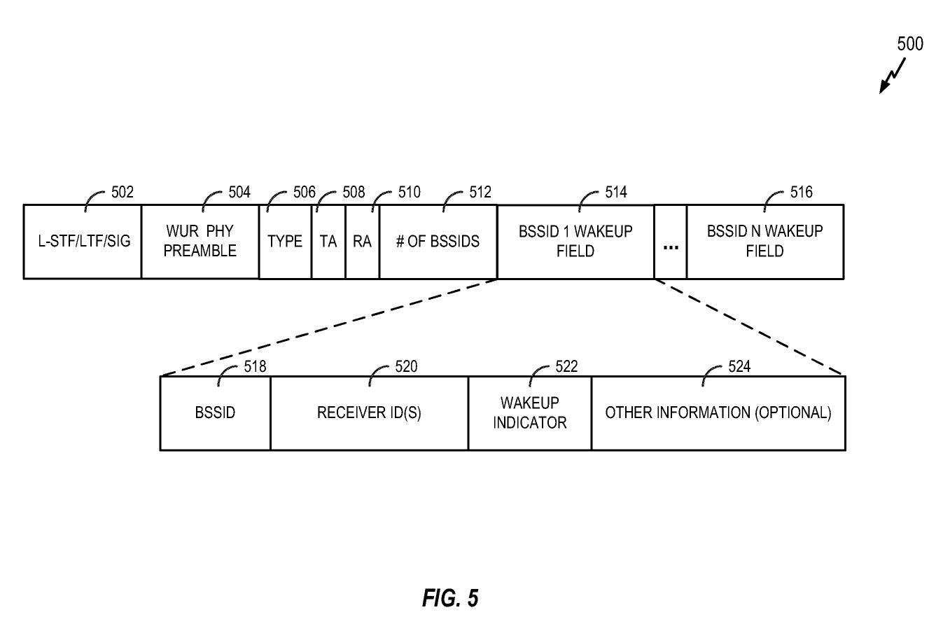

FIG. 5 illustrates an example of a Multiple BSSID Wakeup Frame 500 (e.g., sent by an AP) in accordance with some aspects of the disclosure. The frame 500 may include, for example, one or more of a Legacy field (e.g., including L-STF, L-LTF, and L-SIG) 502, a WUR Physical Layer (PHY) Preamble field 504, a Type field 506, a transmitter address (TA) field 508, a receiver address (RA) field 510, a number (#) of BSSIDs field 512, and one or more Individual BSSID wakeup fields (represented by fields 514 through 516).

The Type field 506 may indicate whether the frame 500 is a single BSSID wakeup frame or a multiple BSSID wakeup frame. For example, the Type field 506 may be one bit where a “0” indicates a single BSSID wakeup frame and a “1” indicates a multiple BSSID wakeup frame, or vice versa.

The transmitter address (TA) field 508 may be set as the transmitted BSSID in some implementations. Alternatively, the TA may be a special TA dedicated to multiple BSSID wakeup frames of this physical AP.

The receiver address (RA) field 510 may be set as a broadcast address in some implementations. Alternatively, the RA may be a special RA dedicated to multiple BSSID wakeup frames of this physical AP.

The number (#) of BSSIDs field 512 may indicate the number of BSSID wakeup fields in the frame 500. For example, if the frame is a multiple BSSID wakeup frame, the # of BSSIDs field 512 could indicate that there are at least 2 wakeup fields.

Each Individual BSSID wakeup field (e.g., fields 514 through 516) may include, for example, a BSSID field 518, at least one Receiver ID field 520, and a Wakeup indicator field 522.

The BSSID field 518 may include the BSSID associated with this wakeup field.

The Receiver ID(s) of the field 520 may include an Individual ID (e.g., a MAC address or an AID), a Broadcast ID, a Group ID, or a TIM bitmap, for selected STAs associated with this BSSID.

The Wakeup indicator in the field 522 may be, for example: 1—for wakeup, 0—for no wakeup. In the latter case, STAs may be configured to just receive the information in the other information field 524.

### Short IDs

To reduce the frame duration, short IDs may be used instead of full IDs (e.g., a full MAC address and an AID, in the highlighted fields). Two options are presented for determining short IDs.

In a first option (Option 1), the AP determines the short ID(s). An AP decides the short ID for each BSSID, TA, RA, broadcast/multicast ID, AID, or any combination thereof. The AP may further signal those short IDs to associated STAs or to those STAs in same multiple BSSID set.

In a second option, (Option 2), a common procedure is used to determine the short ID(s). For example, a full ID may be converted to a corresponding shortened ID via a function known by both the AP and the STA (e.g., published in standards).

### Selection of Single and Multiple BSSID Wakeup Frames

An AP may decide to transmit a single BSSID wakeup frame or a multiple BSSID wakeup frame with the following logic.

If the AP does not support multiple BSSID capability, the AP transmits a single BSSID wakeup frame with the TA set as the AP's media access control (MAC) address and the receiver IDs only for those receivers (e.g., STAs) associated with this AP.

Otherwise, if the AP wants to wake up Multi-BSS Receive capable STAs from at least two different BSSs of the multiple BSSID set, the AP can transmit a multiple BSSID wakeup frame with the TA set as the transmitted BSSID. A Multi-BSS Receive capable STA may have a “Rx Control Frame to Multi-BSS” bit set as 1 in its capabilities information (e.g., its 802.11ax high efficiency (HE) capabilities element) to indicate that the STA, when associated with a BSS corresponding to a non-transmitted BSSID, supports reception of a control frame with TA equal to the transmitted BSSID.

The AP typically would not send a multiple BSSID wakeup frame to STAs not capable of Multi-BSS reception.

### RA Setting Rule in Response Frame

After receiving an AP's multiple BSSID wakeup frame, a STA will turn on its main radio and may send a response frame to inform the AP that the main radio is ready. The response frame can be a power save poll (PS-Poll).

Setting the RA in the response frame to a multiple BSSID wakeup frame may use the following options. In a first option (Option 1), the RA is set as the transmitted BSSID. In a second option (Option 2), the RA is set as the BSSID of the STA's associated BSS. In a third option (Option 3), the RA is set as either the transmitted BSSID or the BSSID of the STA's associated BSS.

### WIRELESS COMMUNICATION EXAMPLES

The teachings herein may be implemented using various wireless technologies and/or various spectra. Wireless network technologies may include various types of wireless local area networks (WLANs). A WLAN may be used to interconnect nearby devices together, employing widely used networking protocols. The various aspects described herein may apply to any communication standard, such as Wi-Fi or, more generally, any member of the IEEE 802.11 family of wireless protocols.

In some aspects, wireless signals may be transmitted according to an 802.11 protocol using orthogonal frequency-division multiplexing (OFDM), direct-sequence spread spectrum (DSSS) communication, a combination of OFDM and DSSS communication, or other schemes.

Certain of the devices described herein may further implement Multiple Input Multiple Output (MIMO) technology and be implemented as part of an 802.11 protocol. A MIMO system employs multiple (Nₜ) transmit antennas and multiple (Nᵣ) receive antennas for data transmission. A MIMO channel formed by the Nₜ transmit and Nᵣ receive antennas may be decomposed into Nₛ independent channels, which are also referred to as spatial channels or streams, where Nₛ≤min{Nₜ, Nᵣ}. Each of the Nₛ independent channels corresponds to a dimension. The MIMO system can provide improved performance (e.g., higher throughput and/or greater reliability) if the additional dimensionalities created by the multiple transmit and receive antennas are utilized.

In some implementations, a WLAN includes various devices that access the wireless network. For example, there may be two types of devices: access points (“APs”) and clients (also referred to as stations, or “STAs”). In general, an AP serves as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations, a STA may also be used as an AP.

An access point (“AP”) may also include, be implemented as, or known as a Transmit Receive Point (TRP), a NodeB (NB), an eNodeB (eNB), a gNodeB (gNB), a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or reference using some other suitable terminology.

A station “STA” may also include, be implemented as, or known as an access terminal (“AT”), a subscriber station, a subscriber unit, a mobile station, a remote station, a remote terminal, a user terminal, a user agent, a user device, user equipment, a client, a mobile, a mobile node, or referenced using some other suitable terminology. In some implementations, a STA may include a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

A wireless apparatus as taught herein may communicate via one or more wireless communication links that are based on or otherwise support any suitable wireless communication technology. For example, in some aspects a wireless apparatus may associate with a network such as a local area network (e.g., a Wi-Fi network) or a wide area network. To this end, a wireless apparatus may support or otherwise use one or more of a variety of wireless communication technologies, protocols, or standards such as, for example, Wi-Fi, WiMAX, CDMA, TDMA, OFDM, and OFDMA. Also, a wireless apparatus may support or otherwise use one or more of a variety of corresponding modulation or multiplexing schemes. A wireless apparatus may thus include appropriate components (e.g., air interfaces) to establish and communicate via one or more wireless communication links using the above or other wireless communication technologies. For example, a device may include a wireless transceiver with associated transmitter and receiver components that may include various components (e.g., signal generators and signal processors) that facilitate communication over a wireless medium.

The teachings herein may be incorporated into (e.g., implemented within or performed by) a variety of apparatuses (e.g., nodes). In some aspects, an apparatus (e.g., a wireless apparatus) implemented in accordance with the teachings herein may include an access point, a relay, or an access terminal.

A relay may include, be implemented as, or known as a relay node, a relay device, a relay station, a relay apparatus, or some other similar terminology. As discussed above, in some aspects, a relay may include some access terminal functionality and some access point functionality.

In some aspects, a wireless apparatus may include an access device (e.g., an access point) for a communication system. Such an access device provides, for example, connectivity to another network (e.g., a wide area network such as the Internet or a cellular network) via a wired or wireless communication link. Accordingly, the access device enables another device (e.g., a wireless station) to access the other network or some other functionality. In addition, it should be appreciated that one or both of the devices may be portable or, in some cases, relatively non-portable. Also, it should be appreciated that a wireless apparatus also may be capable of transmitting and/or receiving information in a non-wireless manner (e.g., via a wired connection) via an appropriate communication interface.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communication (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3^{rd} Generation Partnership Project” (3GPP), while cdma2000 is described in documents from an organization named “3^{rd} Generation Partnership Project 2” (3GPP2). Although certain aspects of the disclosure may be described using 3GPP terminology, it is to be understood that the teachings herein may be applied to 3GPP (e.g., Rel99, Rel5, Rel6, Rel7) technology, as well as 3GPP2 (e.g., 1×RTT, 1×EV-DO Rel0, RevA, RevB) technology and other technologies.

### Example Beamforming System

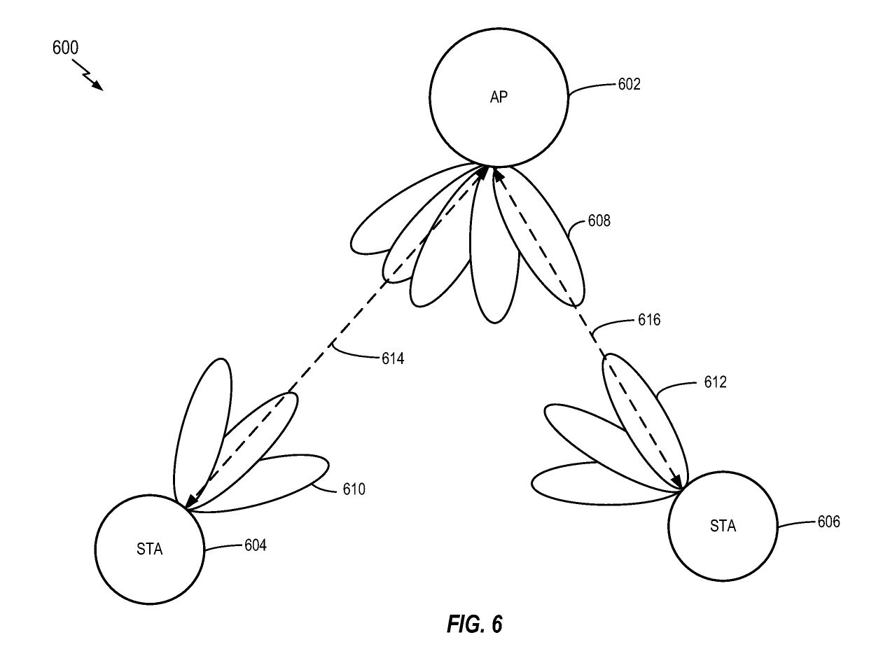

FIG. 6 illustrates a communication system 600 where an access point (AP) 602 communicates with a first STA 604 and a second STA 606 via different beamforming directions. As indicated by a set of beams 608, the AP 602 may communicate via any one of a plural of directional beams. As indicated by a set of beams 610, the first STA 604 may communicate via any one of a plural of directional beams. As indicated by a set of beams 612, the second STA 606 may communicate via any one of a plural of directional beams. For example, the AP 602 may communicate with the first STA 604 via a first beamforming direction 614 and communicate with the second STA 606 via a second beamforming direction 616.

A wireless MIMO system may use multiple transmit antennas to provide beamforming-based signal transmission. Typically, beamforming-based signals transmitted from different antennas are adjusted in phase (and optionally amplitude) such that the resulting signal power is focused toward a receiver device (e.g., an access terminal).

A wireless MIMO system may support communication for a single user at a time or for several users concurrently. Transmissions to a single user (e.g., a single receiver device) are commonly referred to as single-user MIMO (SU-MIMO), while concurrent transmissions to multiple users are commonly referred to as multi-user MIMO (MU-MIMO).

MIMO may be used in a wireless local area network (WLAN) that supports IEEE 802.11ax or some other 802.11-based standard. An AP (e.g., a base station) of an 802.11-based MIMO system employs multiple antennas for data transmission and reception, while each user station (STA) employs one or more antennas. The AP communicates with the STAs via forward link channels and reverse link channels. In some aspects, a downlink (DL) channel refers to a communication channel from a transmit antenna of the access point to a receive antenna of a STA, and an uplink (UL) channel refers to a communication channel from a transmit antenna of a STA to a receive antenna of the AP. Downlink and uplink may be referred to as forward link and reverse link, respectively.

MIMO channels corresponding to transmissions from a set of transmit antennas to a receive antenna are referred to spatial streams since precoding (e.g., beamforming) is employed to direct the transmissions toward the receive antenna. Consequently, in some aspects each spatial stream corresponds to at least one dimension. A MIMO system thus provides improved performance (e.g., higher throughput and/or greater reliability) through the use of the additional dimensionalities provided by these spatial streams.

### Example Wireless Communication System

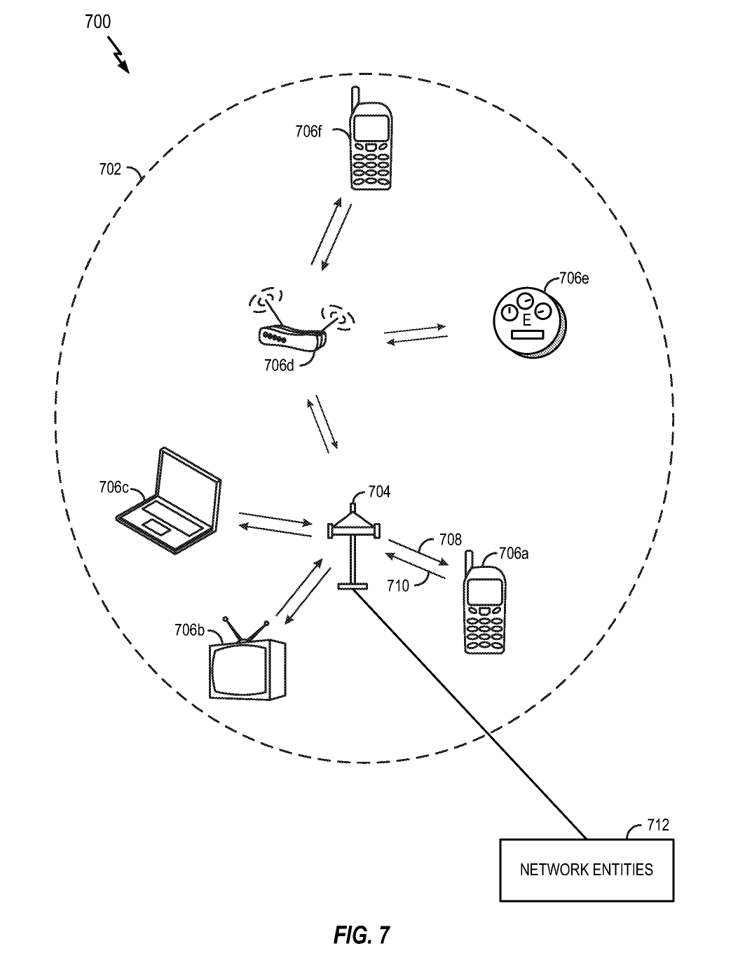

FIG. 7 illustrates an example of a wireless communication system 700 in which aspects of the present disclosure may be employed. The wireless communication system 700 may operate pursuant to a wireless standard, for example the 802.11 standard. The wireless communication system 700 may include an AP 704, which communicates with STAs 706a, 706b, 706c, 706d, 706e, and 706f (collectively STAs 706).

STAs 706e and 706f may have difficulty communicating with the AP 704 or may be out of range and unable to communicate with the AP 704. As such, another STA 706d may be configured as a relay device (e.g., a device including STA and AP functionality) that relays communication between the AP 704 and the STAs 706e and 706f.

A variety of processes and methods may be used for transmissions in the wireless communication system 700 between the AP 704 and the STAs 706. For example, signals may be sent and received between the AP 704 and the STAs 706 in accordance with OFDM/OFDMA techniques. If this is the case, the wireless communication system 700 may be referred to as an OFDM/OFDMA system. Alternatively, signals may be sent and received between the AP 704 and the STAs 706 in accordance with CDMA techniques. If this is the case, the wireless communication system 700 may be referred to as a CDMA system.

A communication link that facilitates transmission from the AP 704 to one or more of the STAs 706 may be referred to as a downlink (DL) 708, and a communication link that facilitates transmission from one or more of the STAs 706 to the AP 704 may be referred to as an uplink (UL) 710. Alternatively, a downlink 708 may be referred to as a forward link or a forward channel, and an uplink 710 may be referred to as a reverse link or a reverse channel.

The AP 704 may act as a base station and provide wireless communication coverage in a basic service area (BSA) 702. The AP 704 along with the STAs 706 associated with the AP 704 and that use the AP 704 for communication may be referred to as a basic service set (BSS).

Access points may thus be deployed in a communication network to provide access to one or more services (e.g., network connectivity) for one or more access terminals that may be installed within or that may roam throughout a coverage area of the network. For example, at various points in time an access terminal may connect to the AP 704 or to some other access point in the network (not shown).

Each of the access points may communicate with one or more network entities (represented, for convenience, by network entities 712 in FIG. 7), including each other, to facilitate wide area network connectivity. A network entity may take various forms such as, for example, one or more radio and/or core network entities. Thus, in various implementations the network entities 712 may represent functionality such as at least one of: network management (e.g., via an authentication, authorization, and accounting (AAA) server), session management, mobility management, gateway functions, interworking functions, database functionality, or some other suitable network functionality. Two or more of such network entities may be co-located and/or two or more of such network entities may be distributed throughout a network.

It should be noted that in some implementations the wireless communication system 700 might not have a central AP 704, but rather may function as a peer-to-peer network between the STAs 706. Accordingly, the functions of the AP 704 described herein may alternatively be performed by one or more of the STAs 706. Also, as mentioned above, a relay may incorporate at least some of the functionality of an AP and a STA.

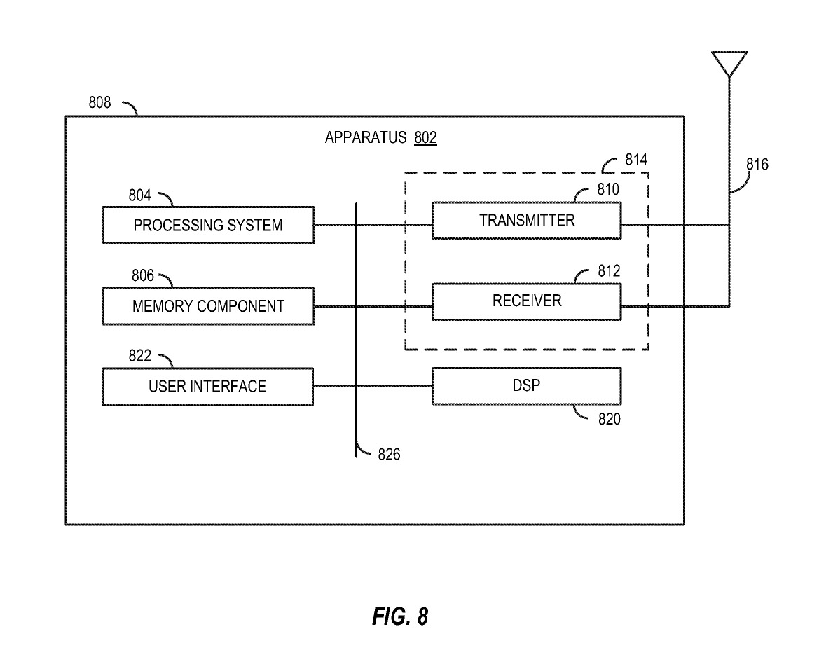

FIG. 8 illustrates various components that may be utilized in an apparatus 802 (e.g., a wireless device) that may be employed within the wireless communication system 700. The apparatus 802 is an example of a device that may be configured to implement the various methods described herein. For example, the apparatus 802 may include (e.g., may be) the AP 704, a relay (e.g., the STA 706d), or one of the STAs 706 of FIG. 7.

The apparatus 802 may include a processing system 804 that controls operation of the apparatus 802. The processing system 804 may also be referred to as a central processing unit (CPU). A memory component 806 (e.g., including a memory device), which may include both read-only memory (ROM) and random access memory (RAM), provides instructions and data to the processing system 804. A portion of the memory component 806 may also include non-volatile random access memory (NVRAM). The processing system 804 typically performs logical and arithmetic operations based on program instructions stored within the memory component 806. The instructions in the memory component 806 may be executable to implement the methods described herein.

When the apparatus 802 is implemented or used as a transmitting node, the processing system 804 may be configured to select one of a plurality of media access control (MAC) header types, and to generate a packet having that MAC header type. For example, the processing system 804 may be configured to generate a packet including a MAC header and a payload and to determine what type of MAC header to use.

When the apparatus 802 is implemented or used as a receiving node, the processing system 804 may be configured to process packets of a plurality of different MAC header types. For example, the processing system 804 may be configured to determine the type of MAC header used in a packet and process the packet and/or fields of the MAC header.

The processing system 804 may include or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The apparatus 802 may also include a housing 808 that may include a transmitter 810 and a receiver 812 to allow transmission and reception of data between the apparatus 802 and a remote location. The transmitter 810 and receiver 812 may be combined into single communication device (e.g., a transceiver 814). An antenna 816 may be attached to the housing 808 and electrically coupled to the transceiver 814. The apparatus 802 may also include (not shown) multiple transmitters, multiple receivers, multiple transceivers, and/or multiple antennas. A transmitter 810 and a receiver 812 may be implemented as an integrated device (e.g., embodied as a transmitter circuit and a receiver circuit of a single communication device) in some implementations, may be implemented as a separate transmitter device and a separate receiver device in some implementations, or may be embodied in other ways in other implementations.

The transmitter 810 may be configured to wirelessly transmit packets having different MAC header types. For example, the transmitter 810 may be configured to transmit packets with different types of headers generated by the processing system 804, discussed above.

The receiver 812 may be configured to wirelessly receive packets having different MAC header type. In some aspects, the receiver 812 is configured to detect a type of a MAC header used and process the packet accordingly.

The receiver 812 may be used to detect and quantify the level of signals received by the transceiver 814. The receiver 812 may detect such signals as total energy, energy per subcarrier per symbol, power spectral density and other signals. The apparatus 802 may also include a digital signal processor (DSP) 820 for use in processing signals. The DSP 820 may be configured to generate a data unit for transmission. In some aspects, the data unit may include a physical layer data unit (PPDU). In some aspects, the PPDU is referred to as a packet.

The apparatus 802 may further include a user interface 822 in some aspects. The user interface 822 may include a keypad, a microphone, a speaker, and/or a display. The user interface 822 may include any element or component that conveys information to a user of the apparatus 802 and/or receives input from the user.

The various components of the apparatus 802 may be coupled together by a bus system 826. The bus system 826 may include a data bus, for example, as well as a power bus, a control signal bus, and a status signal bus in addition to the data bus. Those of skill in the art will appreciate the components of the apparatus 802 may be coupled together or accept or provide inputs to each other using some other mechanism.

Although a number of separate components are illustrated in FIG. 8, one or more of the components may be combined or commonly implemented. For example, the processing system 804 may be used to implement not only the functionality described above with respect to the processing system 804, but also to implement the functionality described above with respect to the transceiver 814 and/or the DSP 820. Further, each of the components illustrated in FIG. 8 may be implemented using a plurality of separate elements. Furthermore, the processing system 804 may be used to implement any of the components, modules, circuits, or the like described below, or each may be implemented using a plurality of separate elements.

For ease of reference, when the apparatus 802 is configured as a transmitting node, it is hereinafter referred to as an apparatus 802t. Similarly, when the apparatus 802 is configured as a receiving node, it is hereinafter referred to as an apparatus 802r. A device in the wireless communication system 700 may implement only functionality of a transmitting node, only functionality of a receiving node, or functionality of both a transmitting node and a receive node.

As discussed above, the apparatus 802 may be implemented as an AP 704 or a STA 706, and may be used to transmit and/or receive communication having a plurality of MAC header types.

The components of FIG. 8 may be implemented in various ways. In some implementations, the components of FIG. 8 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks of FIG. 8 may be implemented by processor and memory component(s) of the apparatus (e.g., by execution of appropriate code and/or by appropriate configuration of processor components). It should be appreciated that these components may be implemented in different types of apparatuses in different implementations (e.g., in an ASIC, in a system-on-a-chip (SoC), etc.).

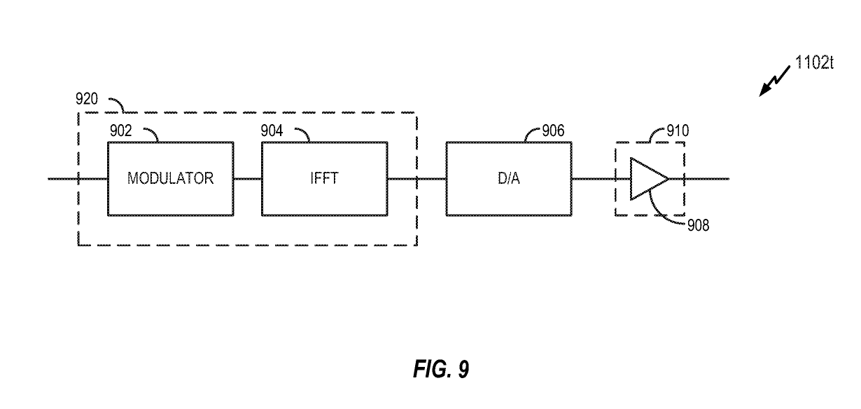

As discussed above, the apparatus 802 may be implemented as an AP 704 or a STA 706, a relay, or some other type of apparatus, and may be used to transmit and/or receive communication. FIG. 9 illustrates various components that may be utilized in the apparatus 802t to transmit wireless communication. The components illustrated in FIG. 9 may be used, for example, to transmit OFDM communication. In some aspects, the components illustrated in FIG. 9 are used to generate and transmit packets to be sent over a bandwidth of less than or equal to 1 MHz.

The apparatus 802t of FIG. 9 may include a modulator 902 configured to modulate bits for transmission. For example, the modulator 902 may determine a plurality of symbols from bits received from the processing system 804 (FIG. 8) or the user interface 822 (FIG. 8), for example by mapping bits to a plurality of symbols according to a constellation. The bits may correspond to user data or to control information. In some aspects, the bits are received in codewords. In one aspect, the modulator 902 may include a QAM (quadrature amplitude modulation) modulator, for example, a 16-QAM modulator or a 64-QAM modulator. In other aspects, the modulator 902 may include a binary phase-shift keying (BPS K) modulator, a quadrature phase-shift keying (QPSK) modulator, or an 8-PSK modulator.

The apparatus 802t may further include a transform module 904 configured to convert symbols or otherwise modulated bits from the modulator 902 into a time domain. In FIG. 9, the transform module 904 is illustrated as being implemented by an inverse fast Fourier transform (IFFT) module. In some implementations, there may be multiple transform modules (not shown) that transform units of data of different sizes. In some implementations, the transform module 904 may be itself configured to transform units of data of different sizes. For example, the transform module 904 may be configured with a plurality of modes, and may use a different number of points to convert the symbols in each mode. For example, the IFFT may have a mode where 32 points are used to convert symbols being transmitted over 32 tones (i.e., subcarriers) into a time domain, and a mode where 64 points are used to convert symbols being transmitted over 64 tones into a time domain. The number of points used by the transform module 904 may be referred to as the size of the transform module 904.

In FIG. 9, the modulator 902 and the transform module 904 are illustrated as being implemented in the DSP 920. In some aspects, however, one or both of the modulator 902 and the transform module 904 are implemented in the processing system 804 or in another element of the apparatus 802t (e.g., see description above with reference to FIG. 8).

As discussed above, the DSP 920 may be configured to generate a data unit for transmission. In some aspects, the modulator 902 and the transform module 904 may be configured to generate a data unit including a plurality of fields including control information and a plurality of data symbols.

Returning to the description of FIG. 9, the apparatus 802t may further include a digital to analog converter 906 configured to convert the output of the transform module into an analog signal. For example, the time-domain output of the transform module 904 may be converted to a baseband OFDM signal by the digital to analog converter 906. The digital to analog converter 906 may be implemented in the processing system 804 or in another element of the apparatus 802 of FIG. 8. In some aspects, the digital to analog converter 906 is implemented in the transceiver 814 (FIG. 8) or in a data transmit processor.

The analog signal may be wirelessly transmitted by the transmitter 910. The analog signal may be further processed before being transmitted by the transmitter 910, for example by being filtered or by being upconverted to an intermediate or carrier frequency. In the aspect illustrated in FIG. 9, the transmitter 910 includes a transmit amplifier 908. Prior to being transmitted, the analog signal may be amplified by the transmit amplifier 908. In some aspects, the amplifier 908 may include a low noise amplifier (LNA).

The transmitter 910 is configured to transmit one or more packets or data units in a wireless signal based on the analog signal. The data units may be generated using the processing system 804 (FIG. 8) and/or the DSP 920, for example using the modulator 902 and the transform module 904 as discussed above. Data units that may be generated and transmitted as discussed above are described in additional detail below.

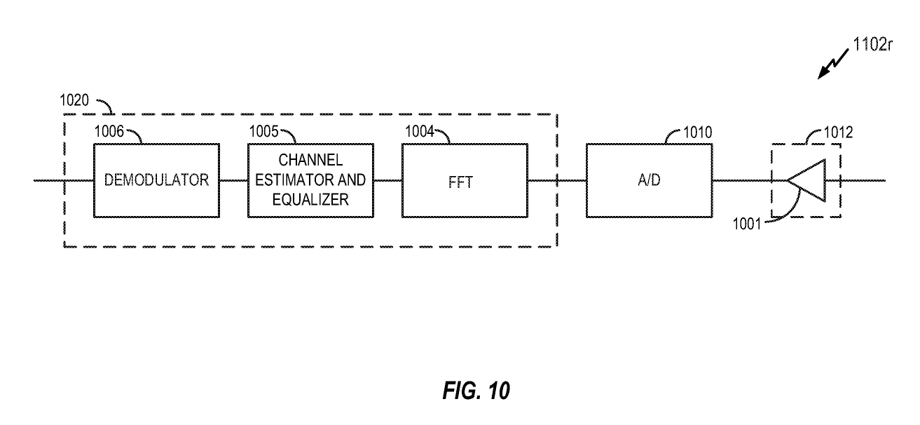

FIG. 10 illustrates various components that may be utilized in the apparatus 802 of FIG. 8 to receive wireless communication. The components illustrated in FIG. 10 may be used, for example, to receive OFDM communication. For example, the components illustrated in FIG. 10 may be used to receive data units transmitted by the components discussed above with respect to FIG. 9.

The receiver 1012 of apparatus 802r is configured to receive one or more packets or data units in a wireless signal. Data units that may be received and decoded or otherwise processed as discussed below.

In the aspect illustrated in FIG. 10, the receiver 1012 includes a receive amplifier 1001. The receive amplifier 1001 may be configured to amplify the wireless signal received by the receiver 1012. In some aspects, the receiver 1012 is configured to adjust the gain of the receive amplifier 1001 using an automatic gain control (AGC) procedure. In some aspects, the automatic gain control uses information in one or more received training fields, such as a received short training field (STF) for example, to adjust the gain. Those having ordinary skill in the art will understand methods for performing AGC. In some aspects, the amplifier 1001 may include an LNA.

The apparatus 802r may include an analog to digital converter 1010 configured to convert the amplified wireless signal from the receiver 1012 into a digital representation thereof. Further to being amplified, the wireless signal may be processed before being converted by the analog to digital converter 1010, for example by being filtered or by being downconverted to an intermediate or baseband frequency. The analog to digital converter 1010 may be implemented in the processing system 804 (FIG. 8) or in another element of the apparatus 802r. In some aspects, the analog to digital converter 1010 is implemented in the transceiver 814 (FIG. 8) or in a data receive processor.

The apparatus 802r may further include a transform module 1004 configured to convert the representation of the wireless signal into a frequency spectrum. In FIG. 10, the transform module 1004 is illustrated as being implemented by a fast Fourier transform (FFT) module. In some aspects, the transform module may identify a symbol for each point that it uses. As described above with reference to FIG. 9, the transform module 1004 may be configured with a plurality of modes, and may use a different number of points to convert the signal in each mode. The number of points used by the transform module 1004 may be referred to as the size of the transform module 1004. In some aspects, the transform module 1004 may identify a symbol for each point that it uses.

The apparatus 802r may further include a channel estimator and equalizer 1005 configured to form an estimate of the channel over which the data unit is received, and to remove certain effects of the channel based on the channel estimate. For example, the channel estimator and equalizer 1005 may be configured to approximate a function of the channel, and the channel equalizer may be configured to apply an inverse of that function to the data in the frequency spectrum.

The apparatus 802r may further include a demodulator 1006 configured to demodulate the equalized data. For example, the demodulator 1006 may determine a plurality of bits from symbols output by the transform module 1004 and the channel estimator and equalizer 1005, for example by reversing a mapping of bits to a symbol in a constellation. The bits may be processed or evaluated by the processing system 804 (FIG. 8), or used to display or otherwise output information to the user interface 822 (FIG. 8). In this way, data and/or information may be decoded. In some aspects, the bits correspond to codewords. In one aspect, the demodulator 1006 may include a QAM (quadrature amplitude modulation) demodulator, for example an 8-QAM demodulator or a 64-QAM demodulator. In other aspects, the demodulator 1006 may include a binary phase-shift keying (BPSK) demodulator or a quadrature phase-shift keying (QPSK) demodulator.

In FIG. 10, the transform module 1004, the channel estimator and equalizer 1005, and the demodulator 1006 are illustrated as being implemented in the DSP 1020. In some aspects, however, one or more of the transform module 1004, the channel estimator and equalizer 1005, and the demodulator 1006 are implemented in the processing system 804 (FIG. 8) or in another element of the apparatus 802 (FIG. 8).

As discussed above, the wireless signal received at the receiver 812 may include one or more data units. Using the functions or components described above, the data units or data symbols therein may be decoded evaluated or otherwise evaluated or processed. For example, the processing system 804 (FIG. 8) and/or the DSP 1020 may be used to decode data symbols in the data units using the transform module 1004, the channel estimator and equalizer 1005, and the demodulator 1006.

Data units exchanged by the AP 704 and the STA 706 may include control information or data, as discussed above. At the physical (PHY) layer, these data units may be referred to as physical layer protocol data units (PPDUs). In some aspects, a PPDU may be referred to as a packet or physical layer packet. Each PPDU may include a preamble and a payload. The preamble may include training fields and a SIG field. The payload may include a Media Access Control (MAC) header or data for other layers, and/or user data, for example. The payload may be transmitted using one or more data symbols. The systems, methods, and devices herein may utilize data units with training fields whose peak-to-power ratio has been minimized.

The apparatus 802t shown in FIG. 9 is an example of a single transmit chain used for transmitting via an antenna. The apparatus 802r shown in FIG. 10 is an example of a single receive chain used for receiving via an antenna. In some implementations, the apparatus 802t or 802r may implement a portion of a MIMO system using multiple antennas to simultaneously transmit data.

The wireless communication system 700 may employ methods to allow efficient access of the wireless medium based on unpredictable data transmissions while avoiding collisions. As such, in accordance with various aspects, the wireless communication system 700 performs carrier sense multiple access/collision avoidance (CSMA/CA) that may be referred to as the Distributed Coordination Function (DCF). More generally, an apparatus 802 having data for transmission senses the wireless medium to determine if the channel is already occupied. If the apparatus 802 senses the channel is idle, then the apparatus 802 transmits prepared data. Otherwise, the apparatus 802 may defer for some period before determining again whether or not the wireless medium is free for transmission. A method for performing CSMA may employ various gaps between consecutive transmissions to avoid collisions. In an aspect, transmissions may be referred to as frames and a gap between frames is referred to as an Interframe Spacing (IFS). Frames may be any one of user data, control frames, management frames, and the like.

IFS time durations may vary depending on the type of time gap provided. Some examples of IFS include a Short Interframe Spacing (SIFS), a Point Interframe Spacing (PIFS), and a DCF Interframe Spacing (DIFS) where SIFS is shorter than PIFS, which is shorter than DIFS. Transmissions following a shorter time duration will have a higher priority than one that must wait longer before attempting to access the channel.

A wireless apparatus may include various components that perform functions based on signals that are transmitted by or received at the wireless apparatus. For example, in some implementations a wireless apparatus may include a user interface configured to output an indication based on a received signal as taught herein.

### Example Communication Device

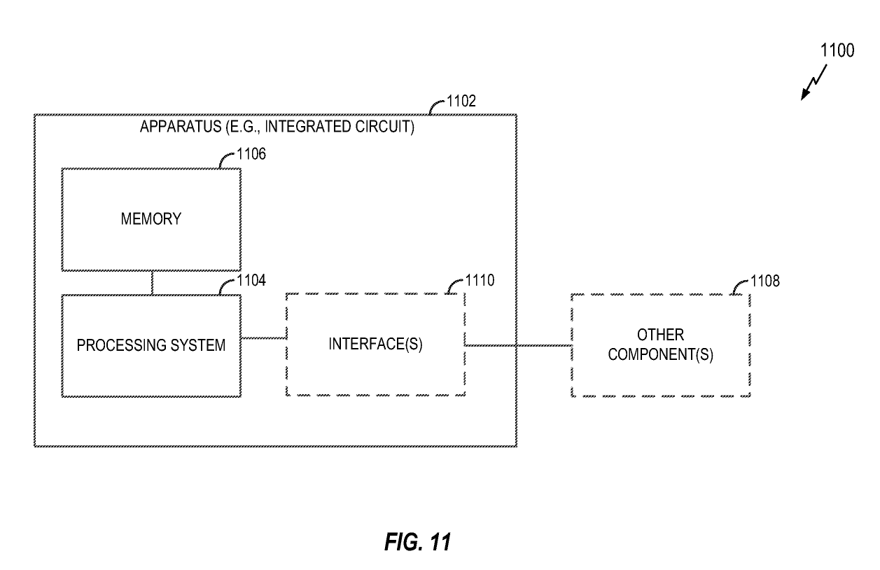

FIG. 11 illustrates an example apparatus 1100 (e.g., an AP, an AT, a BS, a STA, or some other type of wireless communication node) according to certain aspects of the disclosure. The apparatus 1100 includes an apparatus 1102 (e.g., an integrated circuit) and, optionally, at least one other component 1108. In some aspects, the apparatus 1102 may be configured to operate in a wireless communication node (e.g., an AP, an AT, a BS, or a STA) and to perform one or more of the operations described herein. For convenience, a wireless communication node may be referred to herein as a wireless node. The apparatus 1102 includes a processing system 1104, and a memory 1106 coupled to the processing system 1104. Example implementations of the processing system 1104 are provided herein. In some aspects, the processing system 1104 and the memory 1106 of FIG. 11 may correspond to the processing system 804 and the memory component 806 of FIG. 8.

The processing system 1104 is generally adapted for processing, including the execution of such programming stored on the memory 1106. For example, the memory 1106 may store instructions that, when executed by the processing system 1104, cause the processing system 1104 to perform one or more of the operations described herein. As used herein, the terms “programming” or “instructions” or “code” shall be construed broadly to include without limitation instruction sets, instructions, data, code, code segments, program code, programs, programming, subprograms, software modules, applications, software applications, software packages, routines, subroutines, objects, executables, threads of execution, procedures, functions, etc., whether referred to as software, firmware, middleware, microcode, hardware description language, or otherwise.

In some implementations, the apparatus 1102 communicates with at least one other component (e.g., a component 1108 external to the apparatus 1102) of the apparatus 1100. To this end, in some implementations, the apparatus 1102 may include at least one interface 1110 (e.g., a send and/or receive interface) coupled to the processing system 1104 for outputting and/or obtaining (e.g., sending and/or receiving) information (e.g., received information, generated information, decoded information, messages, etc.) between the processing system 1104 and the other component(s) 1108. In some implementations, the interface 1110 may include an interface bus, bus drivers, bus receivers, buffers, other suitable circuitry, or a combination thereof. In some implementations, the interface 1110 may include radio frequency (RF) circuitry (e.g., an RF transmitter and/or an RF receiver). In some implementations, the interface 1110 may be configured to interface the apparatus 1102 to one or more other components of the apparatus 1100 (other components not shown in FIG. 11). For example, the interface 1110 may be configured to interface the processing system 1104 to a radio frequency (RF) front end (e.g., an RF transmitter and/or am RF receiver).

The apparatus 1102 may communicate with other apparatuses in various ways. In cases where the apparatus 1102 includes an RF transceiver (not shown in FIG. 11), the apparatus may transmit and receive information (e.g., a frame, a message, bits, etc.) via RF signaling. In some cases, rather than transmitting information via RF signaling, the apparatus 1102 may have an interface to provide (e.g., output, send, transmit, etc.) information for RF transmission. For example, the processing system 1104 may output information, via a bus interface, to an RF front end for RF transmission. Similarly, rather than receiving information via RF signaling, the apparatus 1102 may have an interface to obtain information that is received by another apparatus. For example, the processing system 1104 may obtain (e.g., receive) information, via a bus interface, from an RF receiver that received the information via RF signaling. In some implementations, an interface may include multiple interfaces. For example, a bidirectional interface may include a first interface for obtaining and a second interface for outputting.

### Example Processes

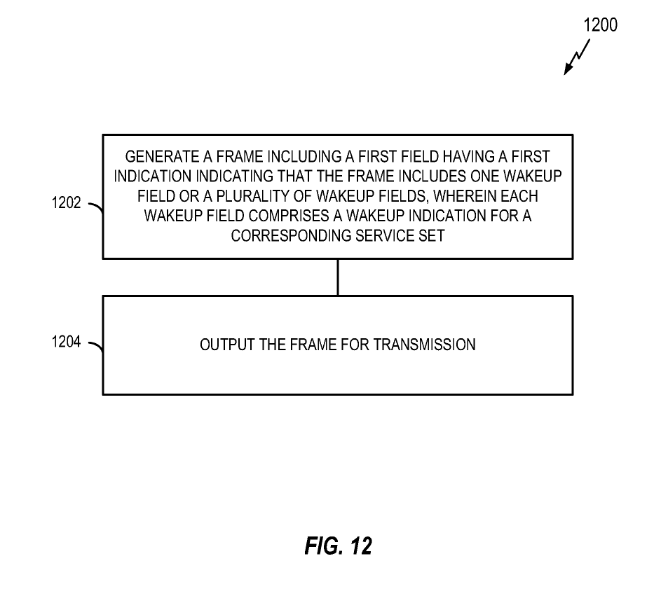

FIG. 12 illustrates a process 1200 for communication in accordance with some aspects of the disclosure. The process 1200 may take place within a processing system (e.g., the processing system 1104 of FIG. 11), which may be located in an AP, a STA, or some other suitable apparatus. Of course, in various aspects within the scope of the disclosure, the process 1200 may be implemented by any suitable apparatus capable of supporting communication-related operations.

At block 1202, an apparatus (e.g., a chip or a transmitting wireless node) generates a frame including a first field having a first indication indicating that the frame includes one wakeup field or a plurality of wakeup fields, wherein each wakeup field includes a wakeup indication for a corresponding service set. In some scenarios, the frame may be an IEEE 802.11ax frame.

A service set may take different forms in different implementations. In some aspects, each service set may include (e.g., may be) an IEEE 802.11 basis service set (BSS). In some aspects, each service set may be associated with a corresponding wireless local area network (WLAN). In some aspects, each service set may be associated with a corresponding virtual access point.

The first indication may take different forms in different implementations. In some aspects, the first indication that the frame includes one wakeup field or a plurality of wakeup fields may take the form of a bit where one value indicates the frame includes one wakeup field and the other value indicates that the frame include a plurality of wakeup fields. In some aspects, the first indication that the frame includes one wakeup field or a plurality of wakeup fields may take the form of a bit where one value indicates the frame is a single BSSID wakeup frame and the other value indicates that the frame is a multiple BSSID wakeup frame. In some aspects, the first indication that the frame includes one wakeup field or a plurality of wakeup fields may take the form of a value that indicates the number of wakeup fields in the frame. In some aspects, the first indication may further indicate that the frame includes the plurality of wakeup fields. In this case, the generation of the frame may involve including in the frame a second field having a second indication of a quantity of the wakeup fields included in the frame. In some aspects, the first indication may further indicate a quantity of the wakeup fields included in the frame.

In some aspects, the generation of the frame may involve including in the frame: a first wakeup field associated with a first service set; a second wakeup field associated with a second service set; and a transmitter address for the frame. Here, the transmitter address may be: an address of a virtual access point, associated with the first service set, associated with a basic service set that the apparatus belongs to, or a dedicated address for multiple service set wakeup frames. In some aspects, the virtual access point may be configured to transmit a multiple BSSID element that includes beacon information for a plurality of virtual access points of a single physical access point.

In some aspects, the process 1200 may further include determining whether to generate the frame for one service set or more than one service set; and setting the first indication. Here the setting of the first indication may involve setting the first indication to indicate that the frame includes a single wakeup field if the determination is that the frame is for one service set, and setting the first indication to indicate that the frame includes more than one wakeup field if the determination is that the frame is for more than one service set. In some aspects, the determination may be based on whether at least two of the more than one service set are each serving at least one wireless node that supports a wakeup frame for multiple service sets. In some aspects, the process 1200 may further include obtaining capability information for each of the at least one wireless node. In this case, the determination may be further based on the capability information.

At block 1204, the apparatus outputs the frame for transmission. For example, a processing system of the apparatus may output a digital signal including the frame to a send interface, a transmitter, a transceiver, or some other component. As another example, an interface may send a digital signal including the frame to a transmitter or a transceiver. As yet another example, a transmitter may transmit a signal (e.g., an RF signal) including the frame (e.g., the frame is transmitted by a low power transmitter).

In some aspects, the process 1200 may further include encoding the frame (e.g., a processing system may encode the frame); outputting the encoded frame for transmission via a dedicated wakeup transmitter; and obtaining a response to the encoded frame via a transceiver (e.g., a high power transceiver is configured to receive a response to the transmitted frame). In some aspects, the encoding may include: encoding the frame using a first communication bandwidth that is narrower than a second communication bandwidth used by the transceiver, encoding the frame at first bit rate that is lower than a second bit rate used by the transceiver, encoding the frame using a first modulation that is less complex than a second modulation used by the transceiver, or any combination thereof. In some aspects, the first modulation may include frequency shift keying. In some aspects, the dedicated wakeup transmitter may configured to: use less power than the transceiver, use a narrower communication bandwidth than the transceiver, send data at a lower bit rate than the transceiver, use less complex modulation than the transceiver, or any combination thereof.

In some aspects, the process 1200 may further include determining at least one shorter address for the frame based on at least one longer address; and including the at least one shorter address in the frame. Here, the at least one longer address may include a media access control (MAC) address, an association identifier (AID), a basis service set identifier (BSSID), a transmitter address, a receiver address, a broadcast address, a multicast address, or any combination thereof.

In some aspects, the process 1200 may include any combination of the above features.

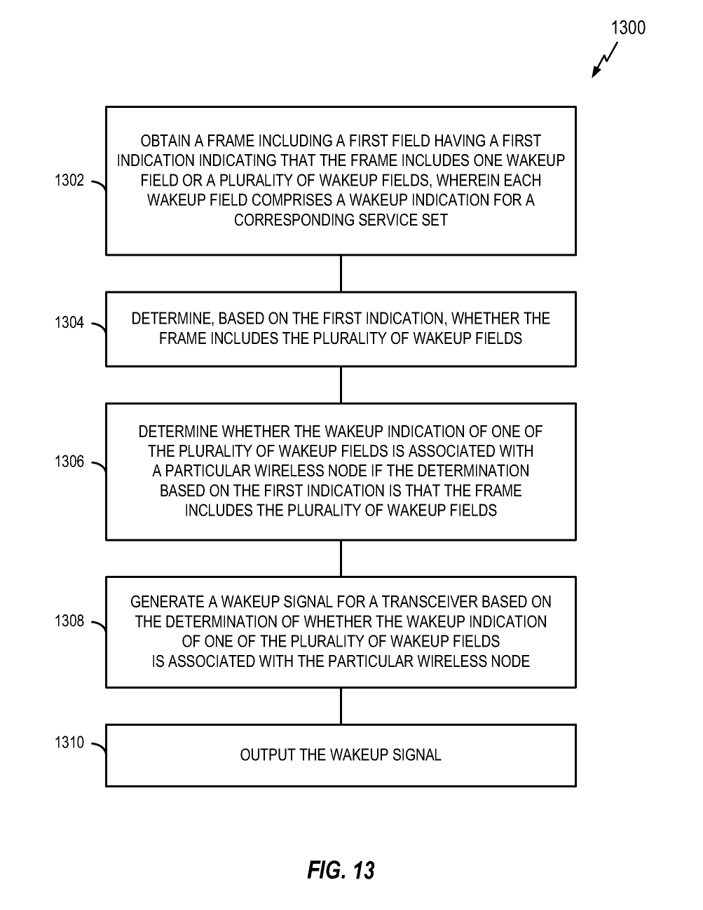

FIG. 13 illustrates a process 1300 for communication in accordance with some aspects of the disclosure. The process 1300 may take place within a processing system (e.g., the processing system 1104 of FIG. 11), which may be located in a STA, an AP, or some other suitable apparatus. Of course, in various aspects within the scope of the disclosure, the process 1300 may be implemented by any suitable apparatus capable of supporting communication-related operations.

At block 1302, an apparatus (e.g., a chip of a receiving wireless node) obtains a frame including a first field for a first indication of whether the frame includes one or more wakeup fields (e.g., the first field has a first indication indicating that the frame includes one wakeup field or a plurality of wakeup fields), wherein each wakeup field includes a wakeup indication for a corresponding service set. For example, a processing system of the apparatus may receive a digital signal including the frame from a receive interface, a receiver, a transceiver, or some other component. As another example, an interface may receive a digital signal including the frame from a receiver or a transceiver. As yet another example, a receiver may receive a signal (e.g., an RF signal) including the frame (e.g., the frame is received by a low power receiver). In some scenarios, the frame may be an IEEE 802.11ax frame.

A service set may take different forms in different implementations. In some aspects, each service set may include (e.g., may be) an IEEE 802.11 basis service set (BSS). In some aspects, each service set may be associated with a corresponding wireless local area network (WLAN). In some aspects, each service set may be associated with a corresponding virtual access point.

The first indication may take different forms in different implementations. In some aspects, the first indication that the frame includes one wakeup field or a plurality of wakeup fields may take the form of a bit where one value indicates the frame includes one wakeup field and the other value indicates that the frame include a plurality of wakeup fields. In some aspects, the first indication that the frame includes one wakeup field or a plurality of wakeup fields may take the form of a bit where one value indicates the frame is a single BSSID wakeup frame and the other value indicates that the frame is a multiple BSSID wakeup frame. In some aspects, the first indication that the frame includes one wakeup field or a plurality of wakeup fields may take the form of a value that indicates the number of wakeup fields in the frame. In some aspects, the first indication may further indicate that the frame includes the plurality of wakeup fields. In this case, the frame may include a second field having a second indication of a quantity of the wakeup fields included in the frame. In some aspects, the first indication may further indicate a quantity of the wakeup fields included in the frame.

At block 1304, the apparatus determines, based on the first indication, whether the frame includes the plurality of wakeup fields.

At block 1306, the apparatus determines whether the wakeup indication of one of the wakeup fields is associated with a particular wireless node if the determination based on the first indication at block 1304 is that the frame includes the plurality of wakeup fields. For example, as a result of a determination that the frame includes a plurality of wakeup fields at block 1304, the apparatus may determine whether any of the wakeup fields include a wakeup indication that is associated with a particular wireless node (e.g., a particular station). Here, the particular wireless node may be the apparatus, the apparatus may be part of the particular wireless node, or the apparatus may be associated with the particular wireless node in some other way.

At block 1308, the apparatus generates a wakeup signal for a transceiver based on the determination of whether the wakeup indication of one of the wakeup fields is associated with the particular wireless node. For example, as a result of a determination that one of the wakeup indications is associated with the particular wireless node at block 1306, the apparatus may generate a wakeup signal to wake up a transceiver of the particular wireless node. In some aspects, this wakeup signal may be used to switch a transceiver from a low power mode (e.g., a sleep mode) to an active mode.

At block 1310, the apparatus outputs the wakeup signal. For example, a processing system of the apparatus may output a digital signal including the wakeup signal to a send interface, a transceiver, or some other component. As another example, an interface may send a digital signal including the wakeup signal to a transceiver.

In some aspects, the process 1300 may further include generating capability information that indicates support for a wakeup frame for multiple service sets; and outputting the capability information for transmission. In this case, the frame may obtained after the outputting of the capability information.

In some aspects, the frame may include a first wakeup field associated with a first service set; the frame may include a second wakeup field associated with a second service set; and the frame may include a transmitter address, where the transmitter address is: an address of a virtual access point, associated with the first service set, associated with a basic service set that a wireless node that transmitted the frame belongs to, or a dedicated address for multiple service set wakeup frames. In this case, the process 1300 may further include generating a response to the frame and outputting the response for transmission. Here, the response may include the transmitter address.

In some aspects, the process 1300 may further include generating a response to the frame and outputting the response for transmission. The response may include a receiver address. The receiver address may include: a basis service set identifier (BSSID) of a virtual access point that transmitted the frame; or a BSSID of a basis service set associated with the apparatus.

In some aspects, the obtaining of the frame may include obtaining the frame from a dedicated wakeup receiver. In this case, the process 1300 may further include decoding the frame, generating a response to the decoded frame, and outputting the response for transmission via a transceiver (e.g., a high power transceiver is configured to transmit the response to the decoded frame). In some aspects, the decoding may include: decoding the frame using a first communication bandwidth that is narrower than a second communication bandwidth used by the transceiver, decoding the frame at first bit rate that is lower than a second bit rate used by the transceiver, decoding the frame according to a first demodulation that is less complex than a second demodulation used by the transceiver, or any combination thereof. In some aspects, the first demodulation may be based on frequency shift keying. In some aspects, the dedicated wakeup receiver may be configured to: use less power than the transceiver, use a narrower communication bandwidth than the transceiver, receive data at a lower bit rate than the transceiver, use less complex demodulation than the transceiver, or any combination thereof.

In some aspects, the frame may include at least one address. In addition, the process 1300 may further include determining at least one longer address based on the at least one address. In some aspects, the at least one longer address may include a media access control (MAC) address, an association identifier (AID), a basis service set identifier (BSSID), a transmitter address, a receiver address, a broadcast address, a multicast address, or any combination thereof.

In some aspects, the process 1300 may include any combination of the above features.

### Example Apparatus

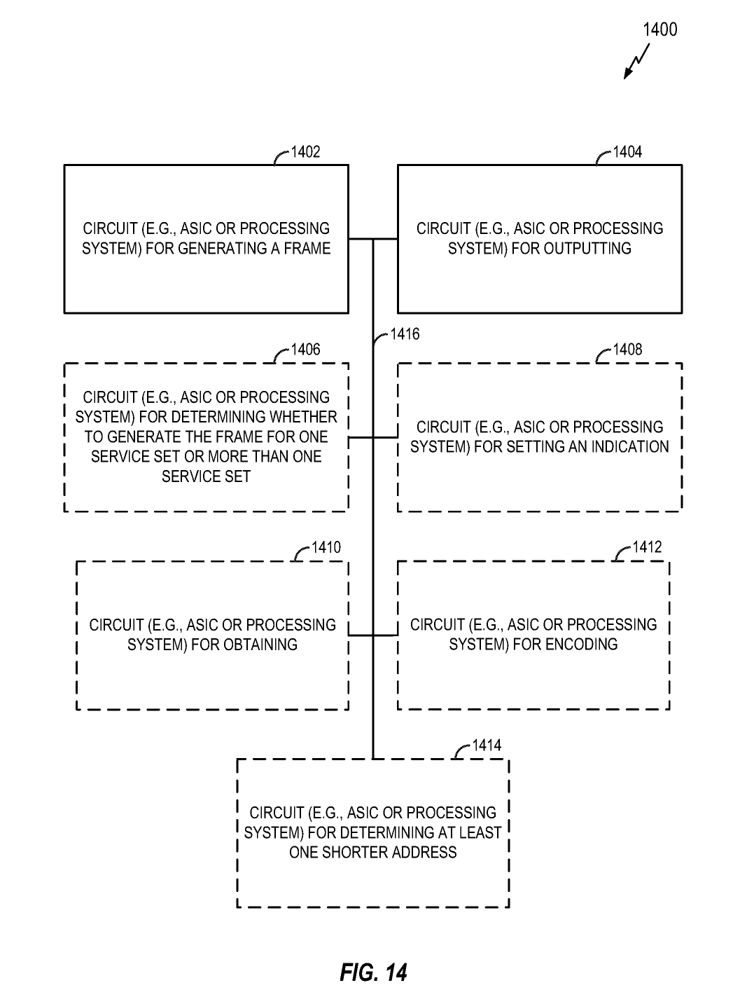

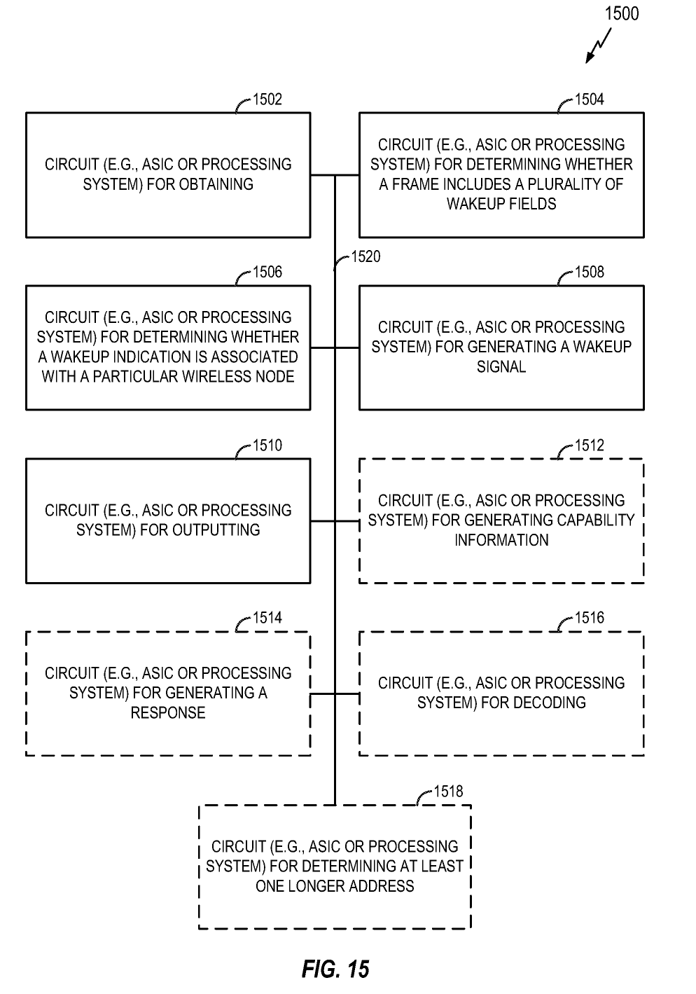

The components described herein may be implemented in a variety of ways. Referring to FIGS. 14 and 15, apparatuses 1400 and 1500 are represented as a series of interrelated functional blocks that represent functions implemented by, for example, one or more integrated circuits (e.g., an ASIC) or implemented in some other manner as taught herein. As discussed herein, an integrated circuit may include a processor, software, other components, or some combination thereof.

The apparatus 1400 includes one or more components (modules) that may perform one or more of the functions described herein with regard to various figures. For example, a circuit (e.g., an ASIC or processing system) for generating a frame 1402, e.g., a means for generating a frame, may correspond to, for example, a processing system as discussed herein. A circuit (e.g., an ASIC or processing system) for outputting 1404, e.g., a means for outputting, may correspond to, for example, an interface (e.g., a bus interface, a send/receive interface, or some other type of signal interface), a communication device, a transceiver, a transmitter, or some other similar component as discussed herein. A circuit (e.g., an ASIC or processing system) for determining whether to generate the frame for one service set or more than one service set 1406, e.g., a means for determining whether to generate the frame for one service set or more than one service set, may correspond to, for example, a processing system as discussed herein. A circuit (e.g., an ASIC or processing system) for setting an indication 1408, e.g., a means for setting an indication, may correspond to, for example, a processing system as discussed herein. A circuit (e.g., an ASIC or processing system) for obtaining 1410, e.g., a means for obtaining, may correspond to, for example, an interface (e.g., a bus interface, a send/receive interface, or some other type of signal interface), a communication device, a transceiver, a receiver, or some other similar component as discussed herein. A circuit (e.g., an ASIC or processing system) for encoding 1412, e.g., a means for encoding, may correspond to, for example, a processing system as discussed herein. A circuit (e.g., an ASIC or processing system) for determining at least one shorter address 1414, e.g., a means for determining at least one shorter address, may correspond to, for example, a processing system as discussed herein. Two or more of the modules of FIG. 14 may communicate with each other or some other component via a signaling bus 1416. In various implementations, the processing system 804 of FIG. 8 and/or the processing system 1104 of FIG. 11 may include one or more of the circuits of FIG. 14.

The apparatus 1500 includes one or more components (modules) that may perform one or more of the functions described herein with regard to various figures. For example, a circuit (e.g., an ASIC or processing system) for obtaining 1502, e.g., a means for obtaining, may correspond to, for example, an interface (e.g., a bus interface, a send/receive interface, or some other type of signal interface), a communication device, a transceiver, a receiver, or some other similar component as discussed herein. A circuit (e.g., an ASIC or processing system) for determining whether a frame includes a plurality of wakeup fields 1504, e.g., a means for determining whether a frame includes a plurality of wakeup fields, may correspond to, for example, a processing system as discussed herein. A circuit (e.g., an ASIC or processing system) for determining whether a wakeup indication is associated with a particular wireless node 1506, e.g., a means for determining whether a wakeup indication is associated with a particular wireless node, may correspond to, for example, a processing system as discussed herein. A circuit (e.g., an ASIC or processing system) for generating a wakeup signal 1508, e.g., a means for generating a wakeup signal, may correspond to, for example, a processing system as discussed herein. A circuit (e.g., an ASIC or processing system) for outputting 1510, e.g., a means for outputting, may correspond to, for example, an interface (e.g., a bus interface, a send/receive interface, or some other type of signal interface), a communication device, a transceiver, a transmitter, or some other similar component as discussed herein. A circuit (e.g., an ASIC or processing system) for generating capability information 1512, e.g., a means for generating capability information, may correspond to, for example, a processing system as discussed herein. A circuit (e.g., an ASIC or processing system) for generating a response 1514, e.g., a means for generating a response, may correspond to, for example, a processing system as discussed herein. A circuit (e.g., an ASIC or processing system) for decoding 1516, e.g., a means for decoding, may correspond to, for example, a processing system as discussed herein. A circuit (e.g., an ASIC or processing system) for determining at least one longer address 1518, e.g., a means for determining at least one longer address, may correspond to, for example, a processing system as discussed herein. Two or more of the modules of FIG. 15 may communicate with each other or some other component via a signaling bus 1520. In various implementations, the processing system 804 of FIG. 8 and/or the processing system 1104 of FIG. 11 may include one or more of the circuits of FIG. 15.

As noted above, in some aspects these modules may be implemented via appropriate processor components. These processor components may in some aspects be implemented, at least in part, using structure as taught herein. In some aspects, a processor may be configured to implement a portion or all of the functionality of one or more of these modules. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. In some aspects, one or more of any components represented by dashed boxes herein are optional.

As noted above, the apparatuses 1400 and 1500 may take the form of or may be implemented in one or more integrated circuits in some implementations. For example, in some aspects a single integrated circuit implements the functionality of one or more of the illustrated components, while in other aspects more than one integrated circuit implements the functionality of one or more of the illustrated components. As one specific example, the apparatus 1400 may be a single device (e.g., with the circuit for generating a frame 1402, the circuit for outputting 1404, the circuit for determining whether to generate the frame for one service set or more than one service set 1406, the circuit for setting an indication 1408, the circuit for obtaining 1410, the circuit for encoding 1412, and the circuit for determining at least one shorter address 1414 implemented as different sections of an ASIC). As another specific example, the apparatus 1400 may be several devices (e.g., with the circuit for generating a frame 1402, the circuit for determining whether to generate the frame for one service set or more than one service set 1406, the circuit for setting an indication 1408, the circuit for encoding 1412, and the circuit for determining at least one shorter address 1414 implemented as one ASIC, and the circuit for outputting 1404 and the circuit for obtaining 1410 implemented as another ASIC).

In addition, the components and functions represented by FIGS. 14 and 15 as well as other components and functions described herein, may be implemented using any suitable means. Such means are implemented, at least in part, using corresponding structure as taught herein. For example, the components described above in conjunction with the “ASIC for” components of FIGS. 14 and 15 correspond to similarly designated “means for” functionality. Thus, one or more of such means is implemented using one or more of processor components, integrated circuits, or other suitable structure as taught herein in some implementations.

The various operations of methods described herein may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar functionality and/or numbering. For example, the blocks of the process 1200 illustrated in FIG. 12 may correspond at least in some aspects, to corresponding blocks of the apparatus 1400 illustrated in FIG. 14. As another example, the blocks of the process 1300 illustrated in FIG. 13 may correspond at least in some aspects, to corresponding blocks of the apparatus 1500 illustrated in FIG. 15.

### Example Programming

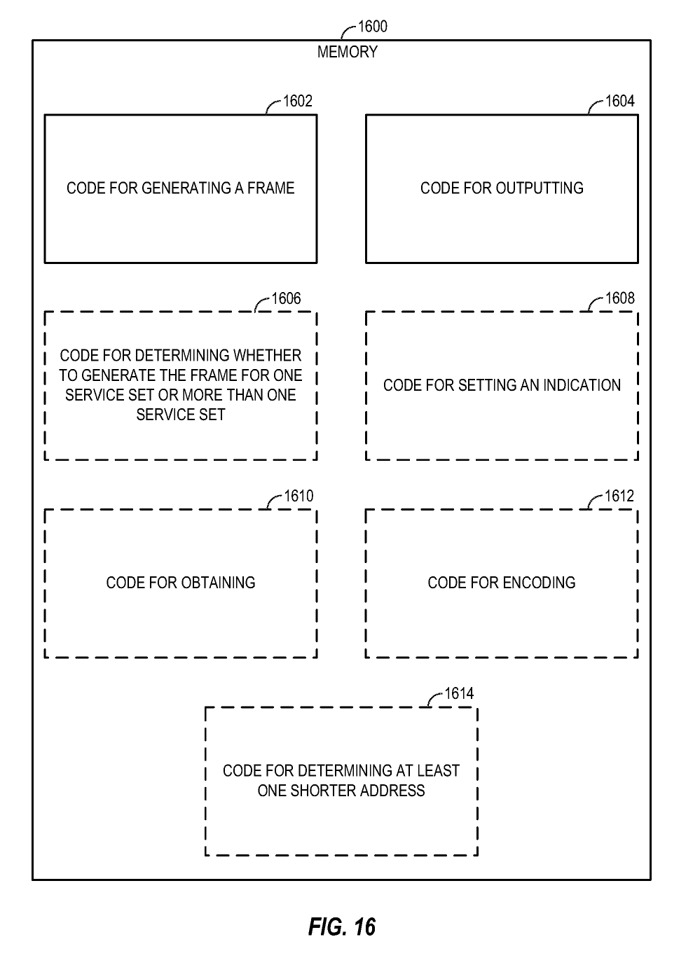

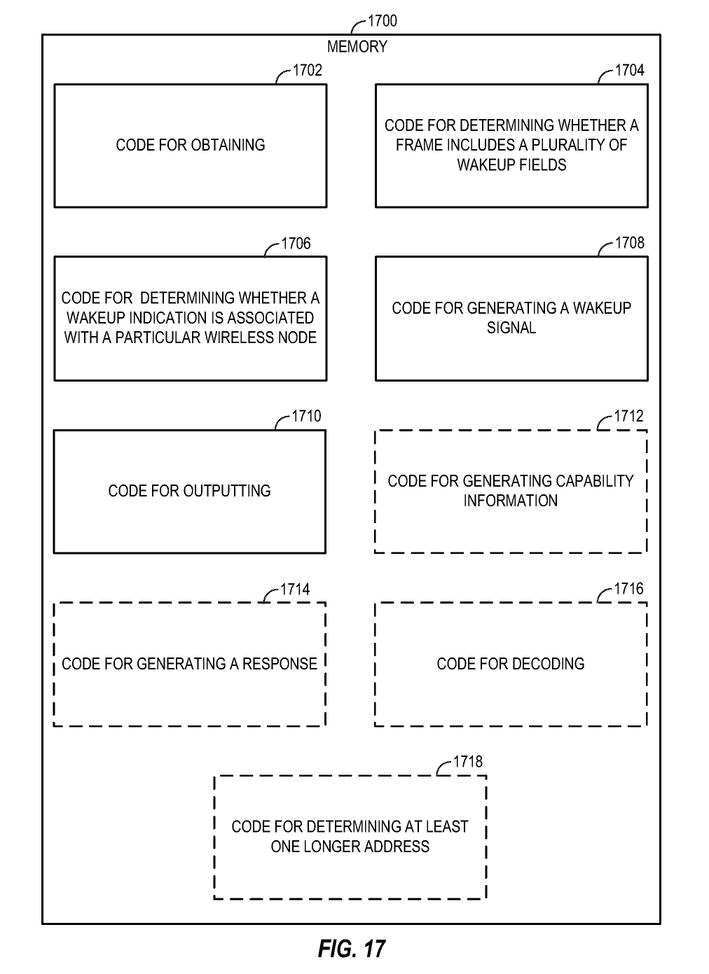

Referring to FIGS. 16 and 17, programming stored by a memory 1600 or a memory 1700 (e.g. a storage medium, a memory device, etc.), when executed by a processing system (e.g., the processing system 1104 of FIG. 11), causes the processing system to perform one or more of the various functions and/or process operations described herein. For example, the programming, when executed by the processing system 1104, may cause the processing system 1104 to perform the various functions, steps, and/or processes described herein with respect to FIGS. 1-8, and 14-15 in various implementations. In some aspects, the memory 1600 or the memory 1700 may correspond to the memory 1106 of FIG. 11.

As shown in FIG. 16, the memory 1600 may include one or more of code for generating a frame 1602, code for outputting 1604, code for determining whether to generate the frame for one service set or more than one service set 1606, code for setting an indication 1608, code for obtaining 1610, code for encoding 1612, or code for determining at least one shorter address 1614. In some aspects, one of more of the code described herein for FIG. 16 may be executed or otherwise used to provide the functionality described herein for the apparatus 1400 of FIG. 14.

As shown in FIG. 17, the memory 1700 may include one or more of code for obtaining 1702, code for determining whether a frame includes a plurality of wakeup fields 1704, code for determining whether a wakeup indication is associated with a particular wireless node 1706, code for generating a wakeup signal 1708, code for outputting 1710, code for generating capability information 1712, code for generating a response 1714, code for decoding 1716, or code for determining at least one longer address 1718. In some aspects, one of more of the code for described herein for FIG. 17 may be executed or otherwise used to provide the functionality described herein for the apparatus 1500 of FIG. 15.

### Additional Aspects

The examples set forth herein are provided to illustrate certain concepts of the disclosure. Those of ordinary skill in the art will comprehend that these are merely illustrative in nature, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

As those skilled in the art will readily appreciate, various aspects described throughout this disclosure may be extended to any suitable telecommunication system, network architecture, and communication standard. By way of example, various aspects may be applied to wide area networks, peer-to-peer network, local area network, other suitable systems, or any combination thereof, including those described by yet-to-be defined standards.

Many aspects are described in terms of sequences of actions to be performed by, for example, elements of a computing device. It will be recognized that various actions described herein can be performed by specific circuits, for example, central processing units (CPUs), graphic processing units (GPUs), digital signal processors (DSPs), application specific integrated circuits (ASICs), field programmable gate arrays (FPGAs), or various other types of general purpose or special purpose processors or circuits, by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

One or more of the components, steps, features and/or functions illustrated in above may be rearranged and/or combined into a single component, step, feature or function or embodied in several components, steps, or functions. Additional elements, components, steps, and/or functions may also be added without departing from novel features disclosed herein. The apparatus, devices, and/or components illustrated above may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An example of a storage medium is coupled to the processor such that the processor can read information from, and write information to, the storage medium. In the alternative, the storage medium may be integral to the processor.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage or mode of operation.

The terminology used herein is for the purpose of describing particular aspects only and is not intended to be limiting of the aspects. As used herein, the singular forms “a,” “an” and “the” are intended to include the plural forms as well, unless the context clearly indicates otherwise. It will be further understood that the terms “comprises,” “comprising,” “includes” or “including,” when used herein, specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “I” between two adjacent words has the same meaning as “or” unless expressly stated otherwise. Moreover, phrases such as “connected to,” “coupled to” or “in communication with” are not limited to direct connections unless expressly stated otherwise.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner. Also, unless stated otherwise a set of elements may comprise one or more elements. In addition, terminology of the form “at least one of a, b, or c” or “a, b, c, or any combination thereof” used in the description or the claims means “a or b or c or any combination of these elements.” For example, this terminology may include a, or b, or c, or a and b, or a and c, or a and b and c, or 2a, or 2b, or 2c, or 2a and b, and so on.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

While the foregoing disclosure shows illustrative aspects, it should be noted that various changes and modifications could be made herein without departing from the scope of the appended claims. The functions, steps or actions of the method claims in accordance with aspects described herein need not be performed in any particular order unless expressly stated otherwise. Furthermore, although elements may be described or claimed in the singular, the plural is contemplated unless limitation to the singular is explicitly stated.

1. An apparatus for communication, comprising:
a processing system configured to:
generate a frame including a first field having a first indication indicating that the frame includes one wakeup field or a plurality of wakeup fields, wherein each wakeup field comprises a wakeup indication for a corresponding service set; and
an interface configured to output the frame for transmission.

2. The apparatus of claim 1, wherein each service set comprises an IEEE 802.11 basis service set (BSS).

3. The apparatus of claim 1, wherein each service set is associated with a corresponding wireless local area network (WLAN).

4. The apparatus of claim 1, wherein each service set is associated with a corresponding virtual access point.

5. The apparatus of claim 1, wherein the first indication indicates that the frame includes the plurality of wakeup fields.

6. The apparatus of claim 5, wherein the generation of the frame comprises including in the frame a second field having a second indication of a quantity of the plurality of wakeup fields included in the frame.

7. The apparatus of claim 1, wherein the first indication indicates a quantity of the plurality of wakeup fields included in the frame.

8. The apparatus of claim 1, wherein the generation of the frame comprises including in the frame:
a first wakeup field associated with a first service set;
a second wakeup field associated with a second service set; and
a transmitter address for the frame, wherein the transmitter address is: an address of a virtual access point, associated with the first service set, associated with a basic service set that the apparatus belongs to, or a dedicated address for multiple service set wakeup frames.

9. The apparatus of claim 1, wherein the processing system is further configured to:
determine whether to generate the frame for one service set or more than one service set;
set the first indication to indicate that the frame includes a single wakeup field if the determination is that the frame is for one service set; and
set the first indication to indicate that the frame includes more than one wakeup field if the determination is that the frame is for more than one service set.

10. The apparatus of claim 9, wherein the determination is based on whether at least two of the more than one service set are each serving at least one wireless node that supports a wakeup frame for multiple service sets.

11. The apparatus of claim 10, wherein:
the interface is further configured to obtain capability information for each of the at least one wireless node; and
the determination is further based on the capability information.

12. The apparatus of claim 1, wherein:
the processing system is further configured to encode the frame;
the outputting of the frame comprises outputting the encoded frame for transmission via a dedicated wakeup transmitter; and
the interface is further configured to obtain a response to the encoded frame via a transceiver.

13. The apparatus of claim 12, wherein the encoding comprises: encoding the frame using a first communication bandwidth that is narrower than a second communication bandwidth used by the transceiver, encoding the frame at first bit rate that is lower than a second bit rate used by the transceiver, encoding the frame using a first modulation that is less complex than a second modulation used by the transceiver, or any combination thereof.

14. The apparatus of claim 13, wherein the first modulation comprises frequency shift keying.

15. The apparatus of claim 1, wherein:
the processing system is further configured to determine at least one shorter address for the frame based on at least one longer address;
the generation of the frame comprises including the at least one shorter address in the frame; and
the at least one longer address comprises a media access control (MAC) address, an association identifier (AID), a basis service set identifier (BSSID), a transmitter address, a receiver address, a broadcast address, a multicast address, or any combination thereof.

16-48. (canceled)

49. A wireless node, comprising:
a processing system configured to generate a frame including a first field having a first indication indicating that the frame includes one wakeup field or a plurality of wakeup fields, wherein each wakeup field comprises a wakeup indication for a corresponding service set; and
a transmitter configured to transmit the frame.

50-54. (canceled)

55. An apparatus for communication, comprising:
an interface configured to obtain a frame including a first field having a first indication indicating that the frame includes one wakeup field or a plurality of wakeup fields, wherein each wakeup field comprises a wakeup indication for a corresponding service set; and
a processing system configured to:
determine, based on the first indication, whether the frame includes the plurality of wakeup fields,
determine whether the wakeup indication of one of the plurality of wakeup fields is associated with a particular wireless node if the determination based on the first indication is that the frame includes the plurality of wakeup fields, and
generate a wakeup signal for a transceiver based on the determination of whether the wakeup indication of one of the plurality of wakeup fields is associated with the particular wireless node,
wherein the interface is further configured to output the wakeup signal.

56. The apparatus of claim 55, wherein each service set: comprises an IEEE 802.11 basis service set (BSS), is associated with a corresponding wireless local area network (WLAN), is associated with a corresponding virtual access point, or any combination thereof.

57. (canceled)

58. (canceled)

59. The apparatus of claim 55, wherein:
the processing system is further configured to generate capability information that indicates support for a wakeup frame for multiple service sets;
the interface is further configured to output the capability information for transmission; and
the frame is obtained after the outputting of the capability information.

60. The apparatus of claim 55, wherein:
the frame includes a first wakeup field associated with a first service set;
the frame includes a second wakeup field associated with a second service set;
the frame includes a transmitter address, wherein the transmitter address is: an address of a virtual access point, associated with the first service set, associated with a basic service set that a wireless node that transmitted the frame belongs to, or a dedicated address for multiple service set wakeup frames;
the processing system is further configured to generate a response to the frame, the response including the transmitter address; and
the interface is further configured to output the response for transmission.

61. The apparatus of claim 55, wherein:
the processing system is further configured to generate a response to the frame, the response including a receiver address; and
the interface is further configured to output the response for transmission.

62. The apparatus of claim 61, wherein the receiver address comprises:
a basis service set identifier (BSSID) of a virtual access point that transmitted the frame; or
a BSSID of a basis service set associated with the apparatus.

63. The apparatus of claim 55, wherein:
the obtaining of the frame comprises obtaining the frame from a dedicated wakeup receiver;
the processing system is further configured to decode the frame;
the processing system is further configured to generate a response to the decoded frame; and
the interface is further configured to output the response for transmission via the transceiver.

64. The apparatus of claim 63, wherein the decoding comprises: decoding the frame using a first communication bandwidth that is narrower than a second communication bandwidth used by the transceiver, decoding the frame at first bit rate that is lower than a second bit rate used by the transceiver, decoding the frame according to a first demodulation that is less complex than a second demodulation used by the transceiver, or any combination thereof.

65. The apparatus of claim 64, wherein the first demodulation is based on frequency shift keying.

66. The apparatus of claim 55, wherein:
the frame includes at least one address;
the processing system is further configured to determine at least one longer address based on the at least one address; and
the at least one longer address comprises a media access control (MAC) address, an association identifier (AID), a basis service set identifier (BSSID), a transmitter address, a receiver address, a broadcast address, a multicast address, or any combination thereof.

67. The apparatus of claim 55, wherein the first indication indicates that the frame includes the plurality of wakeup fields.

68. The apparatus of claim 67, wherein the frame further comprises a second field having a second indication of a quantity of the plurality of wakeup fields included in the frame.

69. The apparatus of claim 55, wherein the first indication indicates a quantity of the plurality of wakeup fields included in the frame.

70-108. (canceled)

109. The apparatus of claim 55, further comprising:
a receiver configured to receive the frame,
wherein the apparatus is configured as a wireless node.
